(19) United States
(12) Patent Application Publication
(10) Pub. No.: US 2026/0113788 A1
(43) Pub. Date: Apr. 23, 2026

(54) Protocol Data Unit (PDU) Session Admission Control

(71) Applicant: Ofinno, LLC, Reston, VA (US)

(72) Inventors: Peyman Talebi Fard, Vienna, VA (US); SungDuck Chun, Fairfax, VA (US); Esmael Hejazi Dinan, McLean, VA (US); Henrik Andreas Normann, Munich (DE)

(73) Assignee: Ofinno, LLC, Reston, VA (US)

(21) Appl. No.: 19/417,719

(22) Filed: Dec. 12, 2025

Related U.S. Application Data
(63) Continuation of application No. PCT/US2024/033261, filed on Jun. 10, 2024.
(60) Provisional application No. 63/472,472, filed on Jun. 12, 2023.

(51) Int. Cl. H04W 74/0833; H04W 36/00; H04W 60/04

(52) U.S. Cl. CPC H04W 74/085; H04W 36/13; H04W 60/04

(57) ABSTRACT

A first network node receives, from a second network node, a message indicating whether a first maximum number of protocol data unit (PDU) sessions, of a multi-access protocol data unit (MA-PDU) established for a wireless device on a network slice, has been reached for a first radio access technology (RAT) type, or a second maximum number of PDU sessions established on the network slice has been reached for a second RAT type.

### CROSS-REFERENCE TO RELATED APPLICATIONS

This application is a continuation of International Application No. PCT/US2024/033261, filed Jun. 10, 2024, which claims the benefit of U.S. Provisional Application No. 63/472,472, filed Jun. 12, 2023, all of which are hereby incorporated by reference in their entireties.

### BRIEF DESCRIPTIONS OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 illustrates an example embodiment of a present disclosure.

FIG. 16 illustrates an example embodiment of a present disclosure.

FIG. 17 illustrates an example embodiment of a present disclosure.

FIG. 18 illustrates an example embodiment of a present disclosure.

FIG. 19 illustrates an example embodiment of a present disclosure.

FIG. 20 illustrates an example embodiment of a present disclosure.

FIG. 21 illustrates an example embodiment of a present disclosure.

FIG. 22 illustrates an example embodiment of a present disclosure.

FIG. 23 illustrates an example embodiment of a present disclosure.

FIG. 24 illustrates an example embodiment of a present disclosure.

FIG. 25 illustrates an example embodiment of a present disclosure.

FIG. 26 illustrates an example embodiment of a present disclosure.

FIG. 27 illustrates an example embodiment of a present disclosure.

FIG. 28 illustrates an example embodiment of a present disclosure.

FIG. 29 illustrates an example embodiment of a present disclosure.

FIG. 30 illustrates an example embodiment of a present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels m ay be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

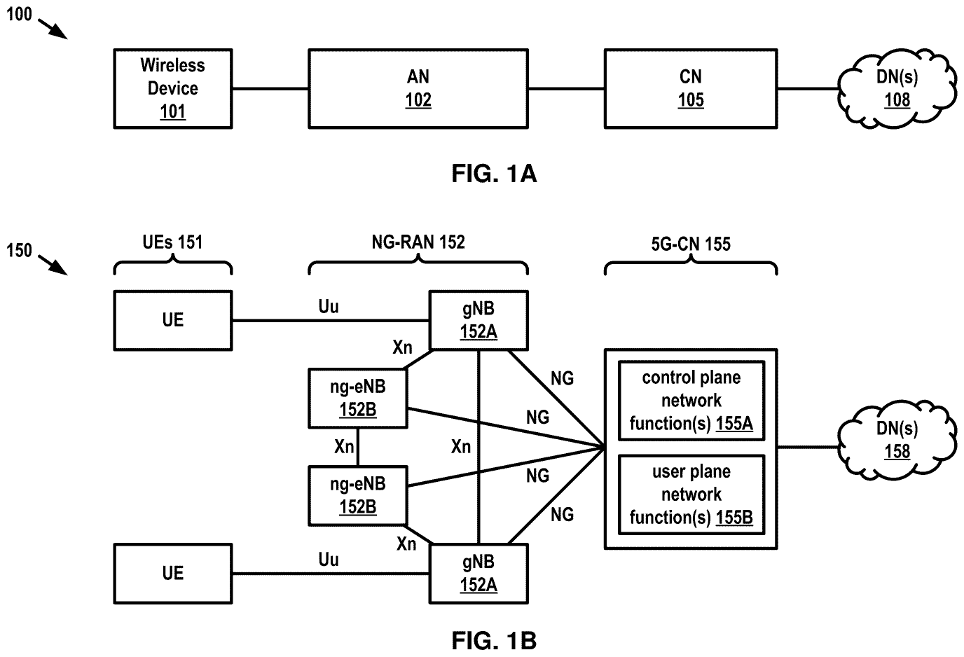

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, WiFi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

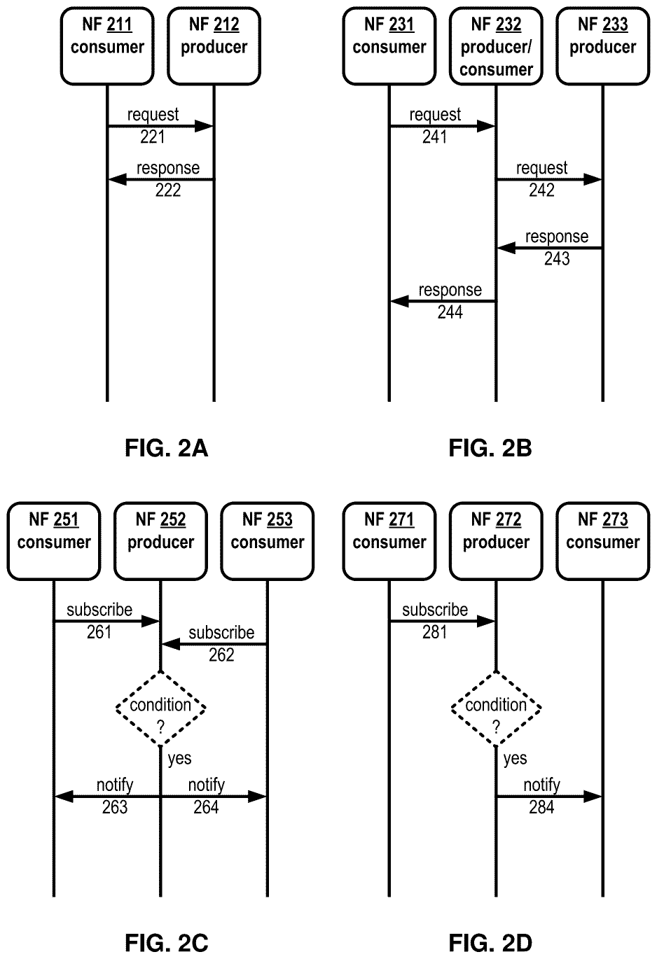

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such as service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 221 to an NF 212 (a producer NF). The request 221 may be a request for a particular service and may be sent based on a discovery that NF 212 is a producer of that service. The request 221 may comprise data relating to NF 211 and/or the requested service. The NF 212 may receive request 221, perform one or more actions associated with the requested service (e.g., retrieving data), and provide a response 221. The one or more actions performed by the NF 212 may be based on request data included in the request 221, data stored by NF 212, and/or data retrieved by NF 212. The response 222 may notify NF 211 that the one or more actions have been completed. The response 222 may comprise response data relating to NF 212, the one or more actions, and/or the requested service.

In the example of FIG. 2B, an NF 231 sends a request 241 to an NF 232. In this example, part of the service produced by NF 232 is to send a request 242 to an NF 233. The NF 233 may perform one or more actions and provide a response 243 to NF 232. Based on response 243, NF 232 may send a response 244 to NF 231. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

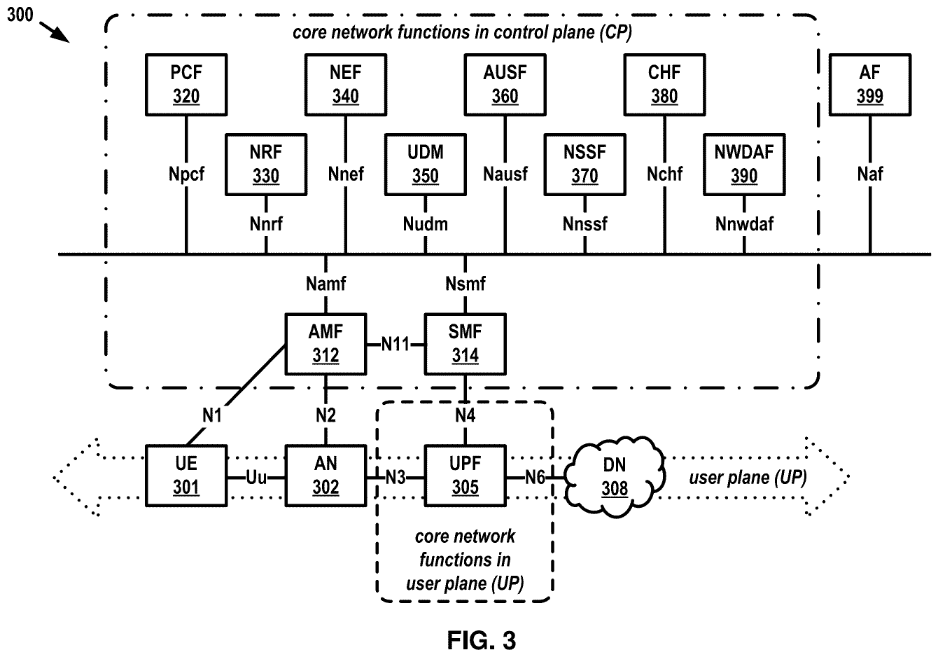

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via ‘N3’, whereas UPF 305 and DN 308 interface via ‘N6’. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

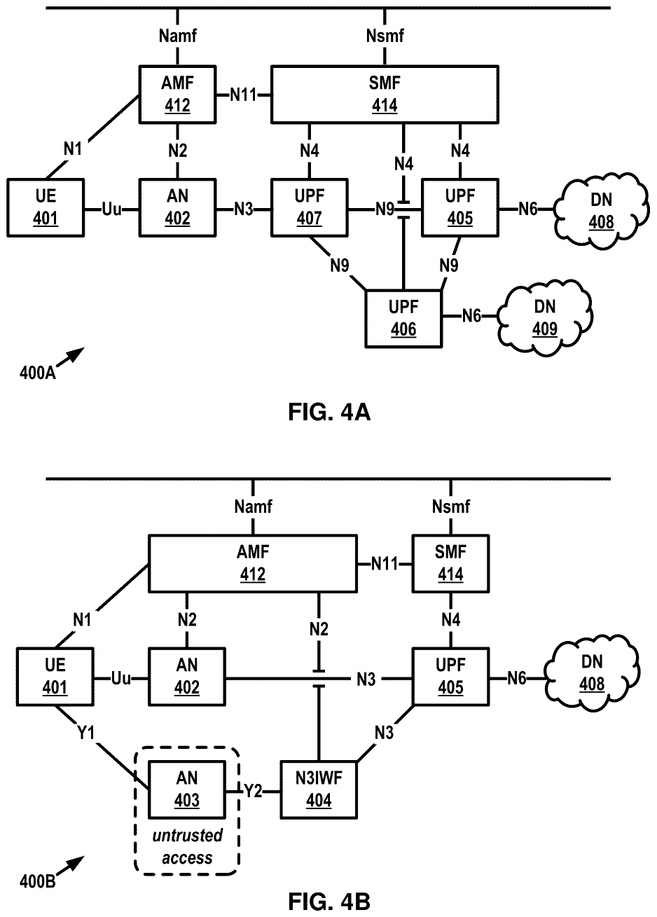

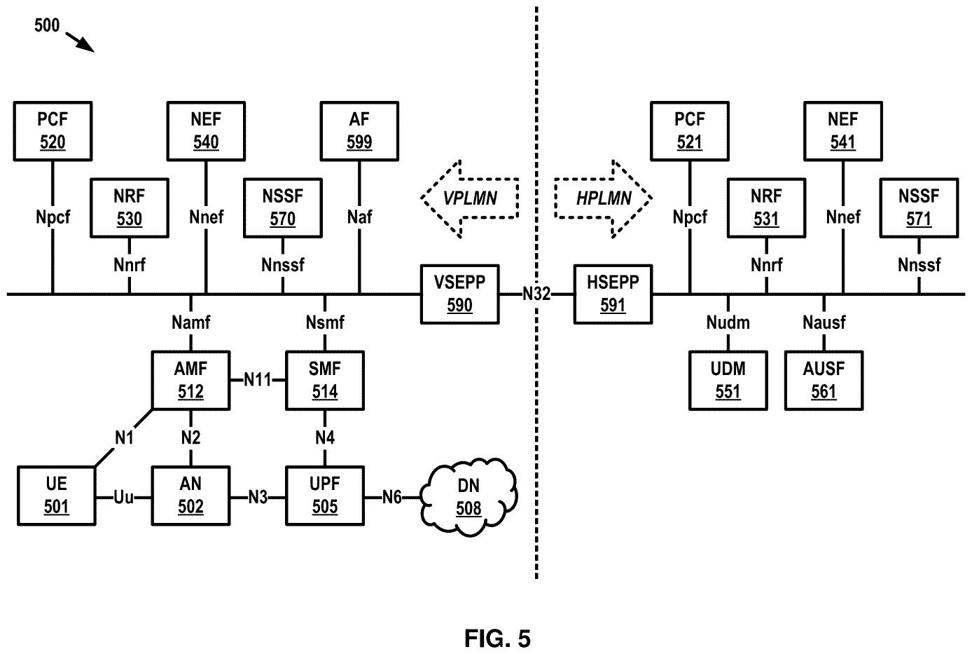

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

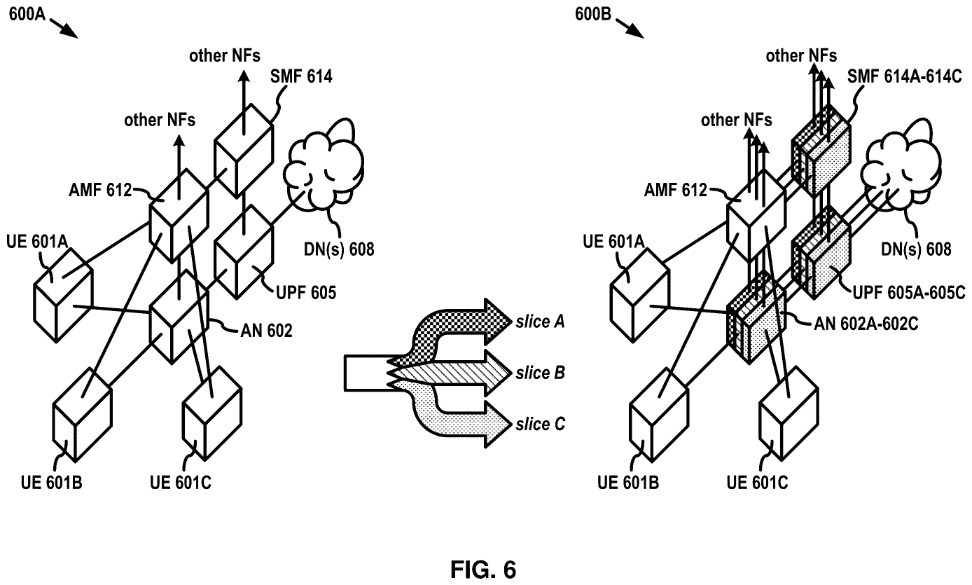

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). as an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacture, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

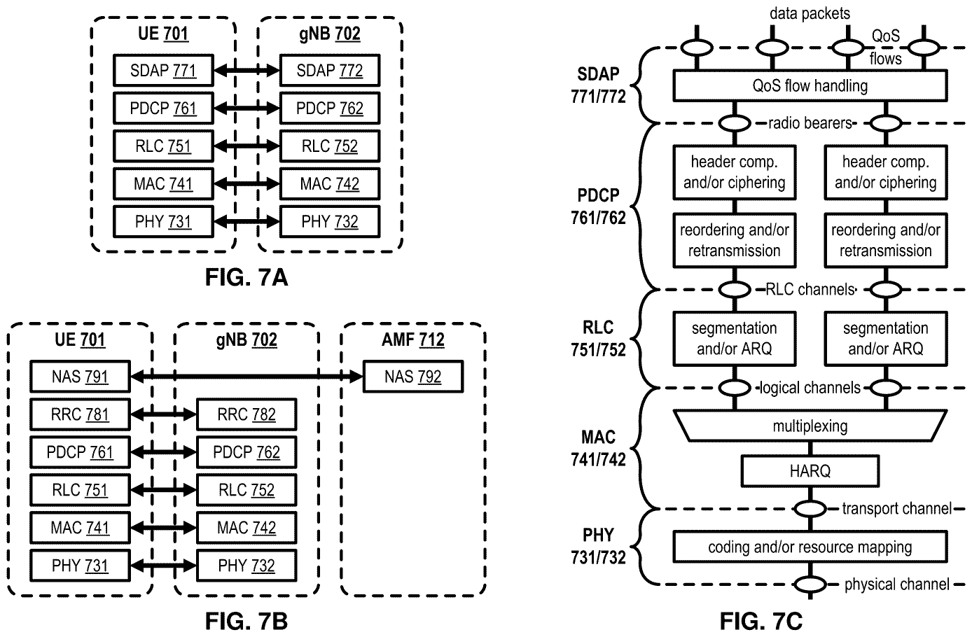

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 220 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 223 may provide RLC channels as a service to PDCPs 214 and 224, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

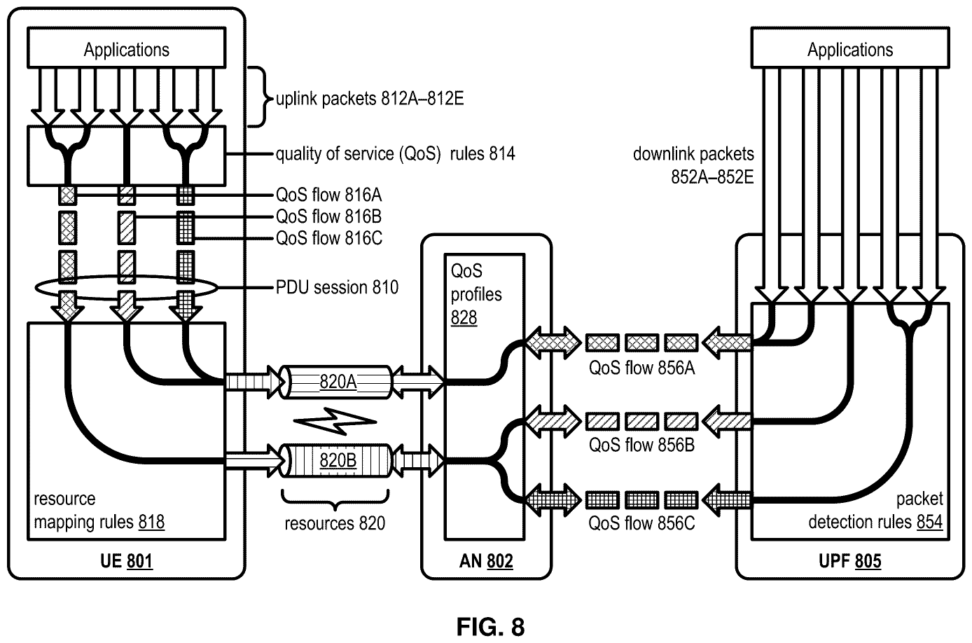

FIG. 8 illustrates an example of a quality of service (QoS) model for differentiated data exchange. In the QoS model of FIG. 8, there are a UE 801, a AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5Q1 which have one-to-one mapping to a standardized combination of 5G QoS characteristics per well-known services. The 5QI may be a dynamically assigned 5QI which the standardized 5Q1 values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

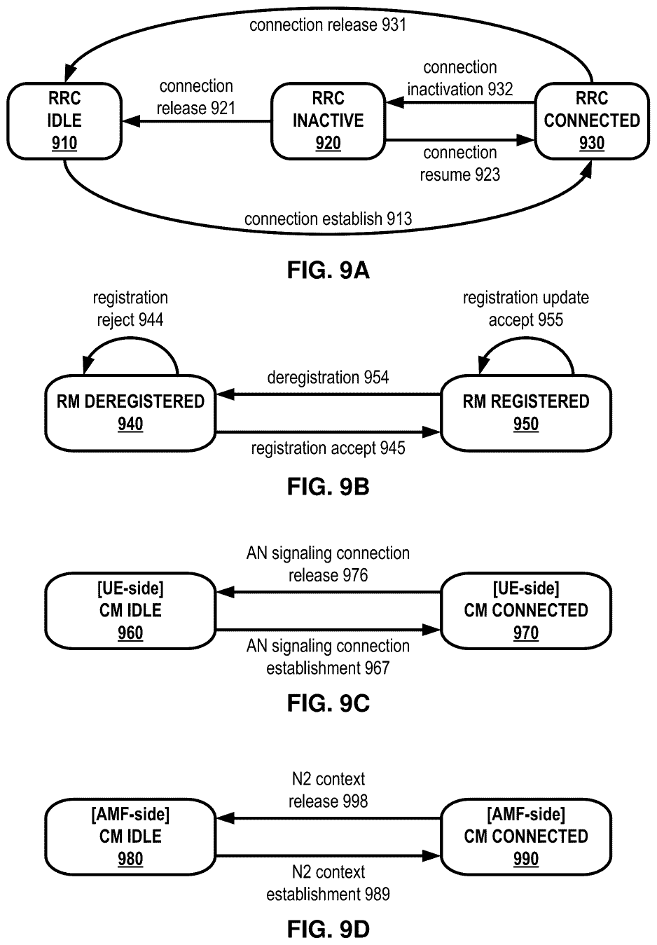

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950.

While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and if necessary use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non access stratum (NAS) signaling connection with the network. As a result, the UE can not communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF many establish an N2 context of the UE (N2 context establishment 989). When the UE transitions from CM connected 990 to CM idle 980, the AMF many release the N2 context of the UE (N2 context release 998).

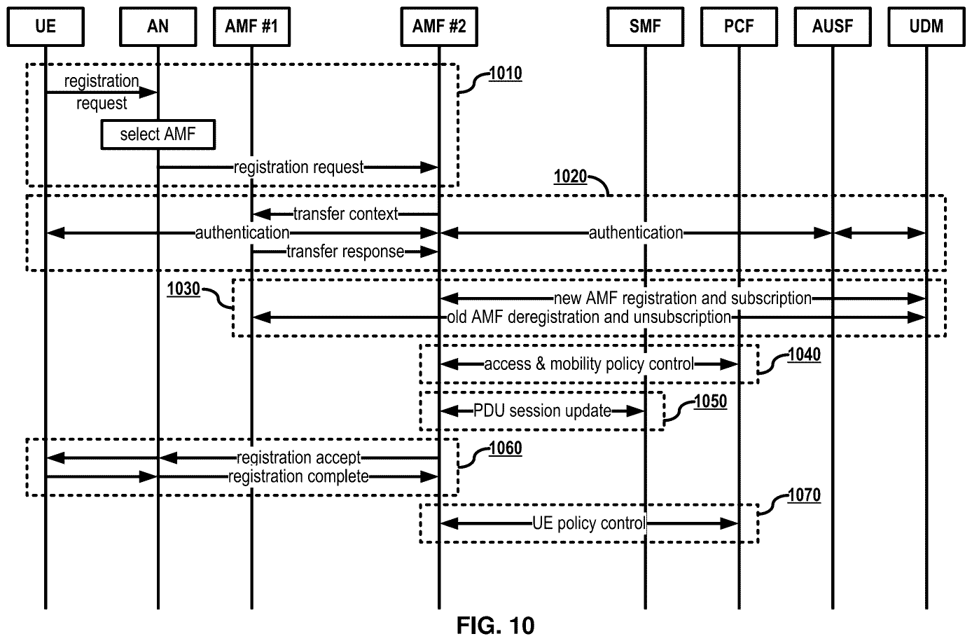

FIGS. 10-12 illustrate example procedures for registering, service request, and PDU session establishment of a UE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

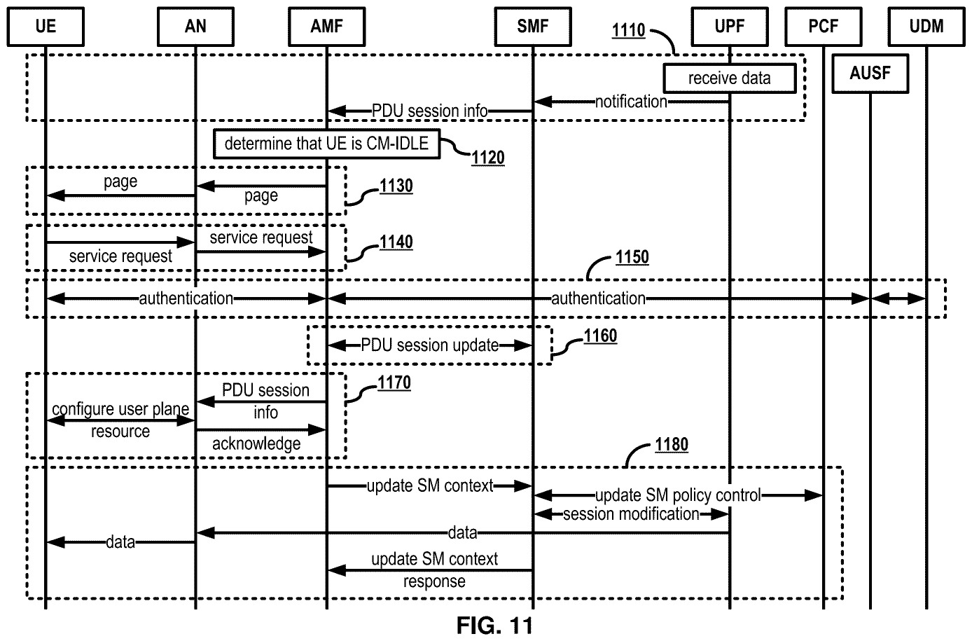

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

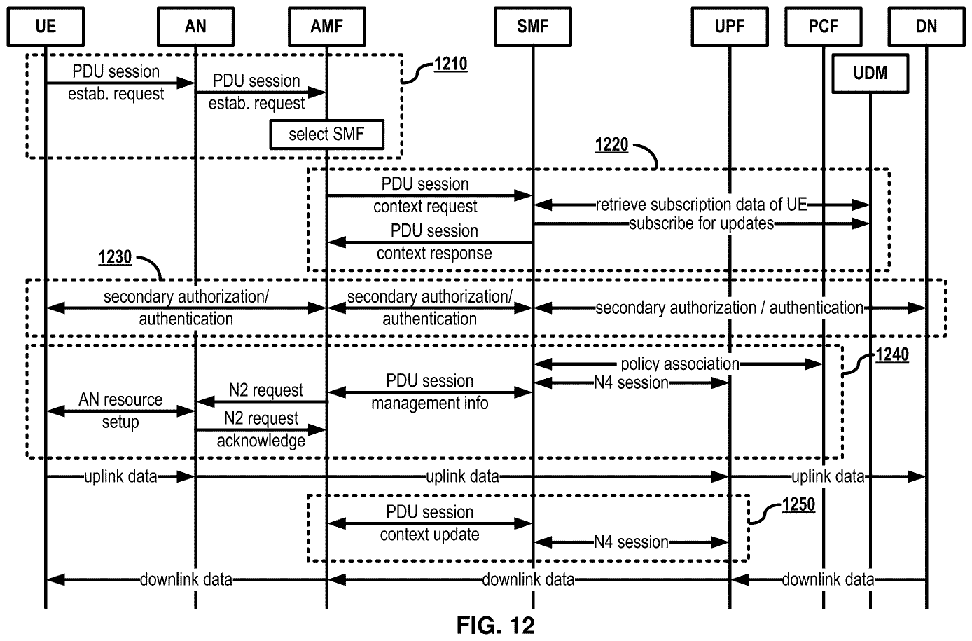

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU session establishment accept message. The PDU session establishment accept message may include tunneling endpoint information of the UPF and quality of service (QoS) information associated with the PDU session.

The AMF may send an N2 request to the AN. The N2 request may include the PDU session establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU session establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

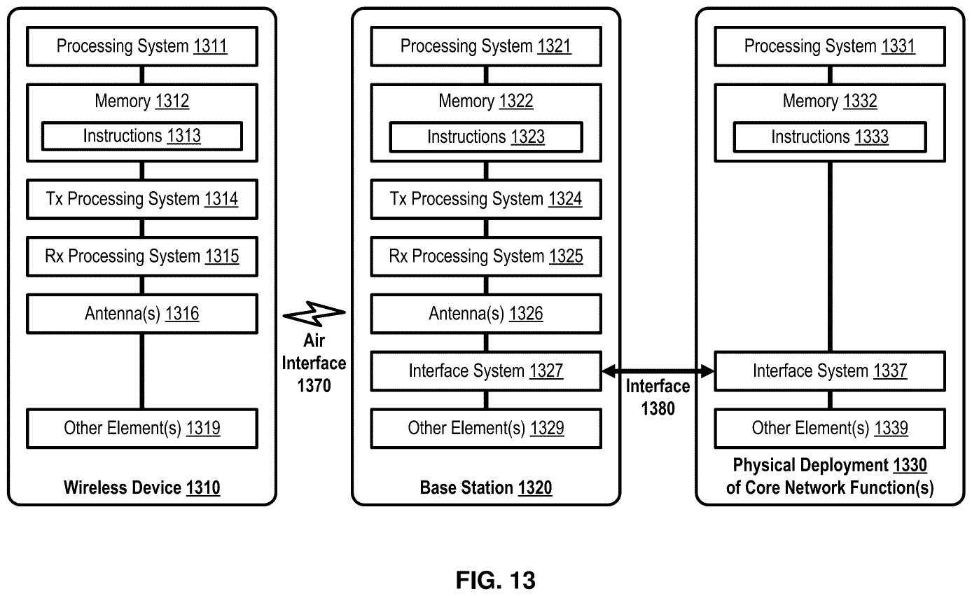

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that may enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

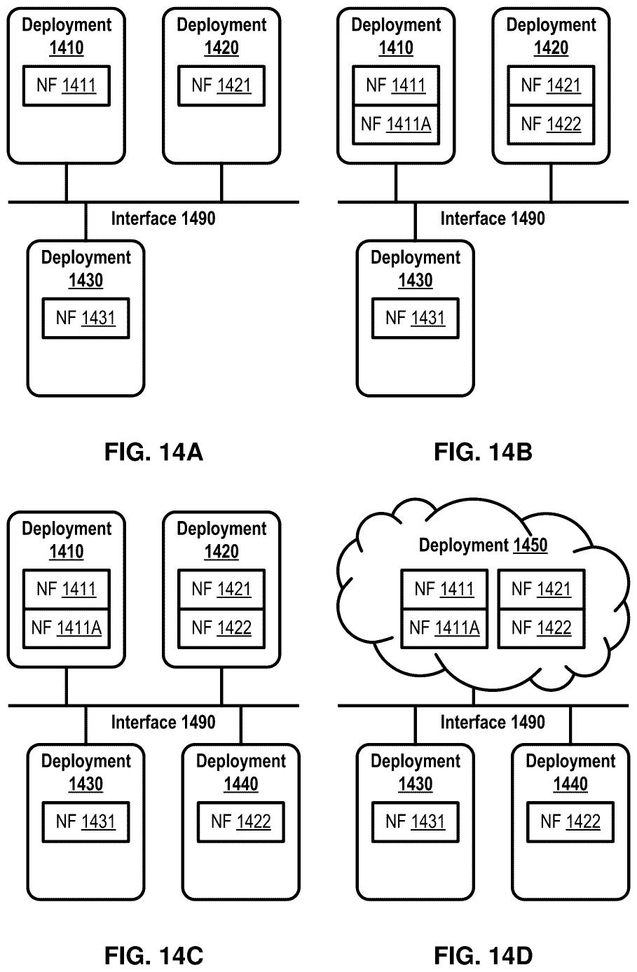

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservices may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

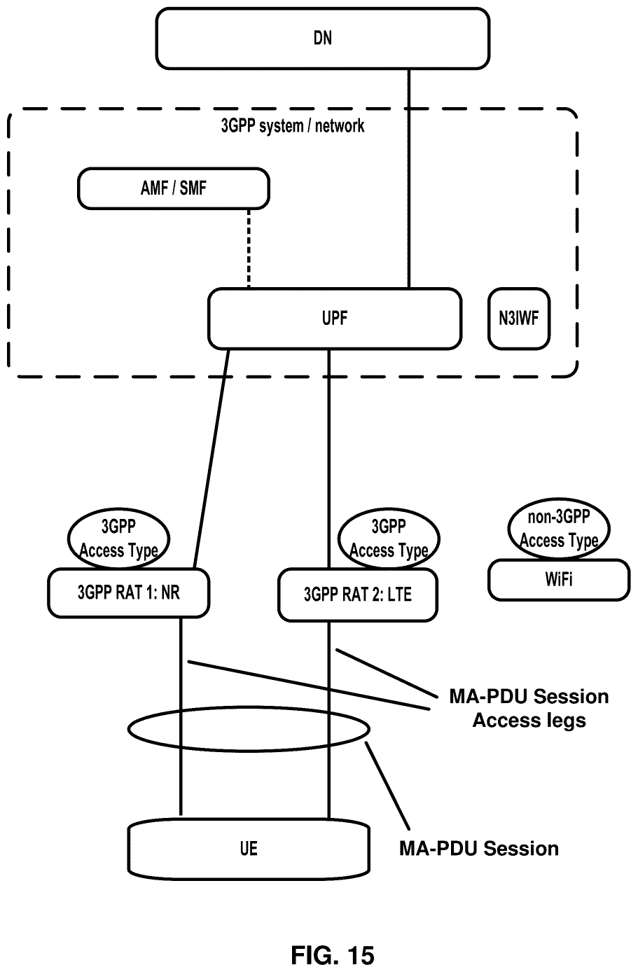

In an example, as depicted in FIG. 15, an access type may be a 3GPP access type or a non-3GPP (N3GPP) access type. In an example, a radio access technology (RAT) type of an access type may refer to the access technology. For example the RAT type of the 3GPP access type may be a new radio (NR), long term evolution (LTE), NR satellite, NR satellite GEO, NR satellite LEO, GSM radio access network (GRAN), EDGE packet radio services with GRAN (GERAN), UMTS radio access network (UTRAN), E-UTRAN, high speed and low latency radio access network, 5G NR, and/or the like. Examples of RAT types for N3GPP access type may comprise trusted or untrusted WiFi access, IEEE based access, wireline access, fixed access, WiMAX, and/or the like.

5GS may support multi access packet data unit PDU sessions (MA-PDU sessions). MA-PDU sessions may simultaneously employ different access types such as 3GPP access types with radio access technology (RAT) types such as NG-RAN, new radio NR, E-UTRA, and/or the like, and/or non-3GPP access type with RAT type or AN type such as WLAN, NB-IoT, E-UTRA, NR, and/or the like. In an example, an NG-RAN node may be a gNB, providing NR user plane and control plane protocol terminations towards a wireless device (UE) and/or, an ng-eNB, providing E-UTRA user plane and control plane protocol terminations towards the UE. Access traffic steering, switching and splitting ATSSS may enable steering, switching and split of data traffic among accesses associated with an MA-PDU session.

In an example, a dual steer (Dualsteer, dual-steer) functionality may enable upper layer traffic steering, switching and split over dual 3GPP access e.g., via one or more RAT types of 3GPP access type as depicted in FIG. 15. The feature may provide enhanced continuity, efficient bandwidth usage and aggregation, improved performance, improved reliability, load balancing, and/or the like. In an example, the dual steer functionality or support may indicate that the UE is capable of ATSSS. In an example, the dual steer functionality or support may indicate that the UE is capable of MA-PDU session. In an example, the dual steer functionality or support may indicate that the UE is capable of MA-PDU session via access legs of the same access type and different RAT types. In an example, the dual steer functionality or support may indicate that the UE is capable of MA-PDU session via access legs of the same access type and same RAT types with different cell IDs, NG-RAN IDs, base station IDs, and/or the like.

In an example the MA-PDU session feature may be employed for management of applications. In an example, an MA-PDU session may be employed to steer, split, switch traffic for application signaling and application data (e.g., media files). In an example, application signaling may be transmitted via a first child session associated to a first access network and user data (e.g., media traffic) may be transmitted via a second child session associated with a second access network.

In an example, an MA-PDU session may be employed for a case where a first child session (e.g., a first access leg) of an MA-PDU session may employ control plane data transmission (e.g., CloT data transmission, CloT control plane optimization, and/or the like) and a second child session (e.g., a second access leg) the MA-PDU session may employ user plane resources and/or employ user plane optimization (e.g., CloT user plane optimization, and/or the like.)

In an example embodiment, access traffic steering, switching and splitting may be employed by the 5GS. In an example, dual steer functionality may be implemented in 5GS. In an example, access traffic steering may be a procedure that may select one or more access network(s) for a new data flow and may transfer the traffic of the data flow over the selected one or more access network(s). Access traffic steering may be applicable between 3GPP and non-3GPP accesses, and/or among different radio access technologies (RAT) types. In an example, access traffic switching may be a procedure that moves traffic of an ongoing data flow from one access network or RAT to another access network or RAT in a way that may maintain continuity of the data flow. In an example, access traffic switching may be applicable between 3GPP and non-3GPP accesses and/or among different RATs as in dual steer functionality.

In an example, access traffic splitting may be a procedure that may split the traffic of a data flow across multiple access networks. When traffic splitting is applied to a data flow, some traffic of the data flow may be transferred via one access and some other traffic of the same data flow may be transferred via another access. Access traffic splitting may be applicable between 3GPP and non-3GPP accesses and/or among different RATs.

In an example, a multi access PDU session (MA-PDU session) may be a PDU session whose traffic may be sent over two 3GPP access types that use different RAT types or via two access legs of the same RAT type, or and/or over one or more RATs.

In an example, a multi access PDU session (MA-PDU session) may be a PDU session whose traffic may be sent over two N3GPP access types that use different RAT types or via two access legs of the same RAT type, or and/or over one or more RATs.

In an example, the multi access PDU session (MA-PDU session) may be a PDU session whose traffic may be sent over 3GPP access, or over non-3GPP access, or over both accesses and/or over one or more RATs.

In an example embodiment, an MA-PDU session may be identified by a MA-PDU session ID, a PDU session ID, an MA-PDU capability flag, access information, and/or the like. In an example, access information may comprise access type (e.g., 3GPP access, non-3GPP access, and/or the like), RAT information (e.g., E-UTRA, NR, WLAN, NB-IoT, cell identifier, access identifier, and/or the like). In an example, access information may be network instance, or an information element indicating access type, RAT, access point identifier, access network identifier, cell identifier, tunneling information, and/or the like. In an example an access leg of the MA-PDU session may be identified by an identifier of the access leg. In an example the identifier of the access leg may comprise at least one of the identifier of a child session of the MA-PDU session, RAT type, base station ID, cell ID, and/or the like associated with the access leg of the MA-PDU session.

In an example embodiment, an access of the MA-PDU session may refer to an access leg, a child session, and/or the like.

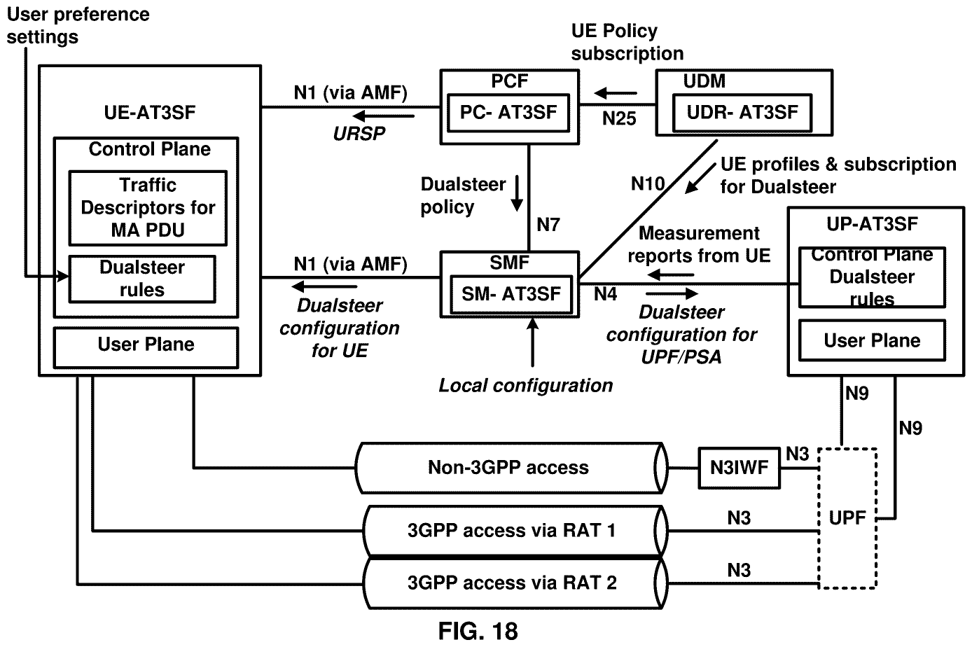

In an example embodiment, different steering modes may be applied for a MA-PDU session. The steering modes may be applied in a MA-PDU session by enforcing an appropriate dual steer policy, ATSSS policy, and/or the like for the MA-PDU session. For example, during the establishment of an MA-PDU session, the PCF in the network may create the dual steer policy for the MA-PDU, which may be transferred to the UE for uplink traffic steering and to a UPF for downlink traffic steering. The dual steer policy may include a prioritized list of dual steer rules or ATSSS rules and each rule may include a steering mode that may be applied to the traffic matching this rule. An example FIG. 18 depicts an example dual steer policy. In the example

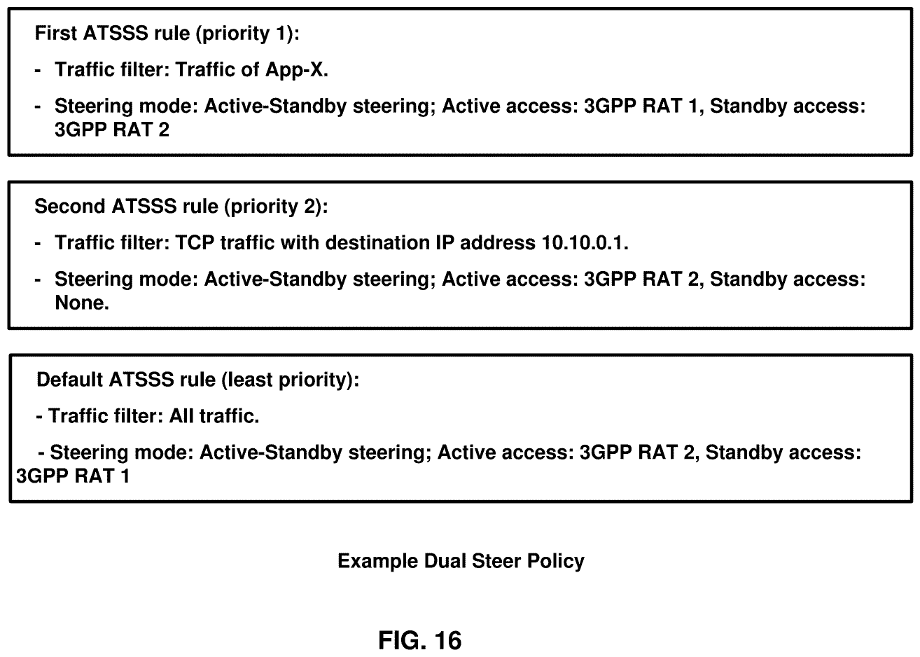

FIG. 16 depicts an example of an ATSSS policy. In FIG. 18, the first ATSSS rule may steer traffic of a first application (App-X). The ATSSS rule may steer traffic of App-X to 3GPP access RAT 1, if 3GPP access RAT 1 is available; or to 3GPP access RAT 2, if 3GPP access RAT 1 is not available. The dualsteer rules may treat (steer, split, etc.) user datagram protocol (UDP) and transport control protocol (TCP) differently. For example, the second ATSSS rule may steer the TCP traffic (traffic that use transport control protocol) with destination IP address 10.10.0.1 to 3GPP access RAT 2 only. Since no standby access is defined, this traffic may not be transferred over 3GPP access RAT 2, even when the 3GPP access becomes unavailable. The default dual steer rule may steer the rest of the traffic.

In an example embodiment, different steering modes may be applied. In an example, an active-standby steering may be employed. In active-standby steering, all (or some of) the traffic of the MA-PDU session may be sent to one access only, which is called the active access. The other access may serve as a standby access and may take traffic when the active access becomes unavailable. When the active access becomes available, the traffic may be transferred to the active access. The active access may be defined when the MA-PDU session is established and may remain the same during the lifetime of the MA-PDU session or may change during the lifetime of the MA-PDU session.

In an example embodiment, a priority-based steering may be employed. The two accesses may be assigned a priority, e.g. during the establishment of the MA-PDU session. All traffic (or some) of the MA-PDU session may be sent to the high priority access. When congestion arises on the high priority access, new data flows (e.g., the overflow traffic) may be sent to the low priority access. When the high priority access becomes unavailable, traffic may be switched to the low priority access. It may be possible to change the priorities of the accesses during the lifetime of the MA-PDU session.

In an example embodiment, best-access steering method may be employed. The high priority access may be the one that may provide the best performance, e.g. the one with the smallest round trip time (RTT). In this case, the high priority access may not be pre-defined (as in Priority-based steering) but it may be estimated and may change.

In an example embodiment, in redundant steering mode all (or some) data flows may be transmitted on both accesses.

In an example embodiment, in load-balance steering mode, each access may receive a percentage of the data flows transmitted via the MA-PDU session. Each access may be assigned a weight factor (e.g. 50%, 80%, and/or the like) and may receive a percentage of the MA-PDU session traffic corresponding to this factor. As an example, in a 50/50 (50%) load-balancing, the overall traffic of the MA-PDU session is equally split across the two accesses. In an 80/20 load-balancing, about 80% of the overall traffic may be sent on one access and 20% on the other access.

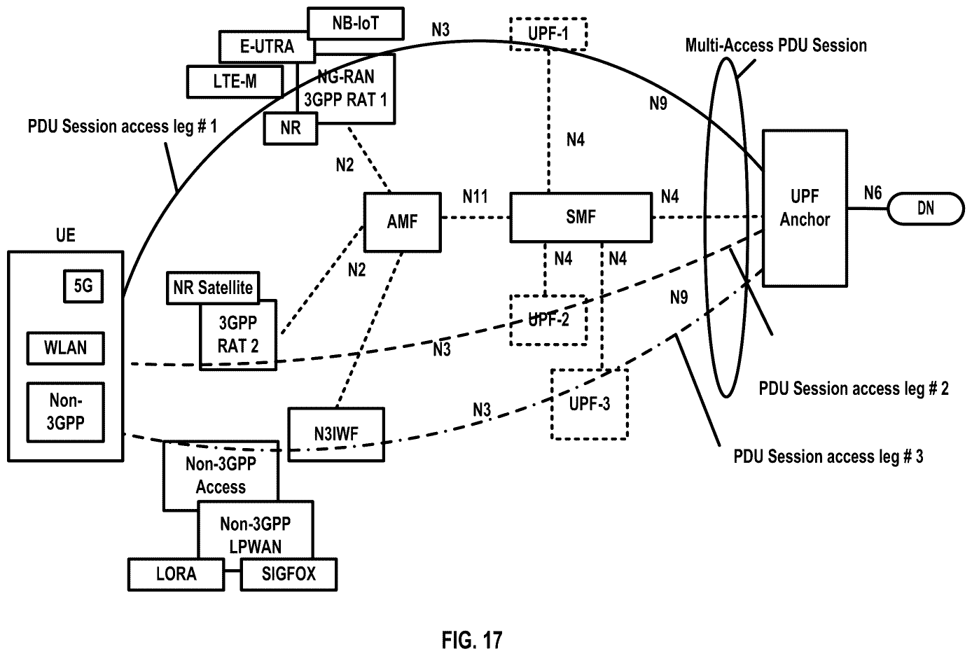

An example FIG. 17 depicts a MA-PDU session with three accesses e.g., child sessions, access legs, (e.g., sub-PDU sessions, child PDU sessions). An MA-PDU session may be created by bundling together two or more separate PDU sessions, which may be established over different accesses or RATs. An MA-PDU session may comprise one, two or more PDU sessions (or sub-PDU sessions), referred to as child PDU sessions; some established over 3GPP access and the others established over untrusted non-3GPP access (e.g. a WLAN AN).

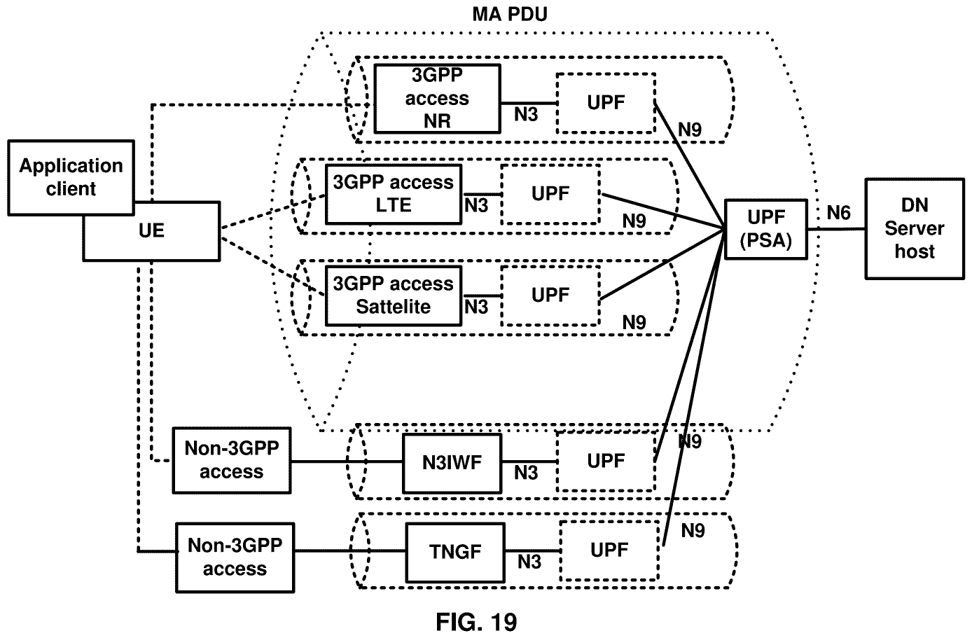

The child PDU sessions of a MA-PDU session may share a common DNN, a common UPF anchor (UPF-A), a common PDU type (e.g. IPv6), a common IP address(es), a common SSC mode, a common S-NSSAI and/or the like. An MA-PDU session may be deployed via a multi-path data link between a UE and an anchor UPF-A, as depicted in FIG. 19.

In an example, an MA-PDU session may be established with separate PDU session establishment procedures; one of each child PDU session, e.g., separate establishment.

In an example, an MA-PDU session may be established with a single MA-PDU session establishment procedure, where the child PDU sessions may be established in parallel, e.g., combined establishment.

In an example, a UE may determine to establish a MA-PDU session based on configured policy in the UE that may indicate whether multi-access is preferred when a PDU session is triggered.

In an example embodiment as depicted in FIG. 18, a wireless device may be capable of dual steer. In an example, dual steer rules and policy may be implemented in the UE, and the network elements such as user plane network elements or control plane network elements.

In an example as depicted in FIG. 19, a MA-PDU session may comprise one or more accesses that may be referred to access legs, child sessions, sub-sessions, and/or the like. In an example, the UE may establish the MA-PDU session to access the network simultaneously via one or more accesses or steer/switch between accesses or access via one access of the MA-PDU session at a time. In an example, accesses of the MA-PDU session may be 3GPP access, N3GPP access, or underlay access. In an example, the UE may access via one or more N3GPP accesses, one or more 3GPP accesses, one or more underlay accesses.

In an example embodiment, measurement assistance information (MAI) may be transmitted by the network to the UE. If the UE is capable of supporting MA-PDU session, and ATSSS (e.g., using multipath TCP (MPTCP) functionality) with any steering mode, the network may send measurement assistance information for the UE to send access availability/unavailability to the UPF.

In an example, existing technologies may support an MA-PDU session of a wireless device wherein one access is established via a 3GPP access type and another access is established via a non-3GPP (N3GPP) access type. In an example, when the MA-PDU session is established via at least two of the same access type with different RAT types, admission control functionality may take into account the access type of the MA-PDU session, as well as total number of UEs allowed for the network slice, for management of total number of PDU sessions allowed for a network slice. For the case of the MA-PDU session, more than one access type may be considered for admission control. However, when access legs of the MA-PDU session employ same access type, the admission control function may not be able to make a proper admission decision or distinguish the two access legs, since the two access legs use the same access type e.g., 3GPP access type. As a consequence, wrong admission decisions may cause inefficient usage of resources and excessive signaling.

Example embodiments improve system performance by signaling enhancements between the wireless device and the network, and/or between the SMF and a network slice admission control function (NSACF) node, and/or between the AMF and the NSACF. In an example signaling enhancements may comprise identification of MA-PDU access legs based on RAT types or other methods to distinguish the access legs that employ the same access type e.g., 3GPP access.

In an example embodiment, a PDU session supporting a multi-access PDU connectivity service is referred to as multi-access PDU (MA-PDU) session. An MA-PDU session is a PDU session which may use at least one 3GPP access network and/or at least one non-3GPP access network at a time, or simultaneously one or more 3GPP access networks and one or more non-3GPP access networks. An MA-PDU session may employ one or more 3GPP access types, one or more N3GPP access types, one or more underlay access networks, and/or the like, at a time or simultaneously. An MA-PDU session may be established when the UE is registered to the same PLMN over 3GPP access network, non-3GPP access network and underlay access or registered to different PLMNs over 3GPP access network, non-3GPP access network, and underlay access respectively. A UE may initiate MA-PDU session establishment when the UE is registered to a PLMN over both 3GPP access network, non-3GPP access network, and underlay access, or only registered to one access network. Therefore, at any given time, the MA-PDU session may have user-plane resources established on at least one or more of 3GPP access, non-3GPP access, and underlay access, or on one access only (either 3GPP access or non-3GPP access, or underlay access), or may have no user-plane resources established on any access.

In an example embodiment, a radio access technology (RAT) may be a sub-type of an access type. In an example, the access type may comprise a 3GPP access, a non-3GPP access, an underlay access, and/or the like. In an example, 3GPP access types may be categorized in different RAT types e.g., new radio (NR), LTE, satellite access, NR satellite access, NR satellite GEO, NR satellite LEO, NR satellite MEO, NR OTHERSAT, UTRA, EUTRA, HSPA, and/or the like. In an example, RAT types for non-3GPP access types may comprise different access network types or technologies such as WiFi, IEEE 80.11, IEEE 802.16, and/or the like. In an example, access information may be satellite access, NR satellite access, NR satellite GEO, NR satellite LEO, NR satellite MEO, NR OTHERSAT, and/or the like.

In an example embodiment, an access leg may refer to a connection of the wireless device to the network wherein the connectivity is via an access network, radio access network, RAN, satellite, and/or the like. For example, the wireless device may have two access legs, wherein the first access leg is via a 3GPP access type and a first RAT type of the 3GPP access type, and the second access leg is via the 3GPP access type and a second RAT type of the 3GPP access type. In an example, the first access leg may be via 3GPP access type, NR satellite and the second access leg may be via the 3GPP access type and LTE RAT type. In an example, a registration, connection, access, and/or the like of the wireless device may be via the access legs. In an example, a PDU session may comprise or may be via two access legs. In an example, an MA-PDU session may comprise or may be established via two access legs.

In an example, the dual steer functionality or support may indicate that the UE is capable of ATSSS. In an example, the dual steer functionality or support may indicate that the UE is capable of MA-PDU session. In an example, the dual steer functionality or support may indicate that the UE is capable of MA-PDU session via access legs of the same access type and different RAT types. In an example, the dual steer functionality or support may indicate that the UE is capable of MA-PDU session via access legs of the same access type and same RAT types with different cell IDs, NG-RAN IDs, base station IDs, and/or the like.

The PDU session establishment procedure may be performed as depicted and described in FIG. 12. When a MA-PDU session is to be established, the PDU session establishment request message may be sent over the 3GPP access and the first RAT type (e.g., AN1, RAT 1). In an example, the UE may provide request type as “MA-PDU Request” in UL NAS Transport message and its dual steer capabilities in PDU Session Establishment Request message. In an example, the NAS message sent by the UE to the AMF or to the SMF, may comprise a dualsteer capability indication. The “MA-PDU Request” Request Type in the UL NAS Transport message may indicate to the network that this PDU Session Establishment Request is to establish a new MA-PDU Session and to apply the ATSSS-LL functionality, or the MPTCP functionality, or both functionalities, for steering the traffic of this MA-PDU session. In an example, if the UE requests an S-NSSAI and the UE is registered over one or more accesses, it may request an S-NSSAI that is allowed on the one or more accesses.

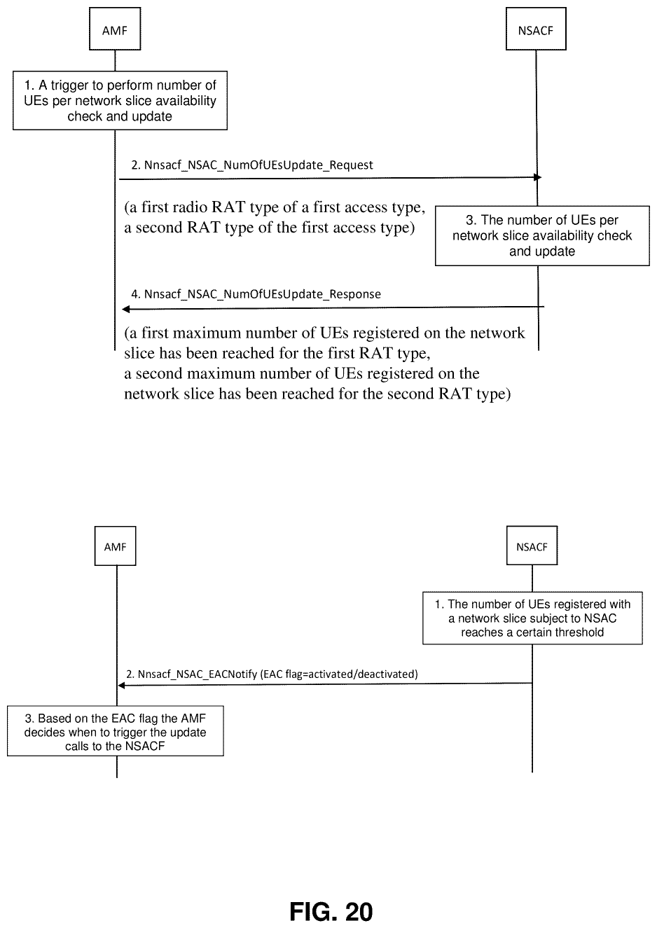

In an example, FIG. 20 may depict an example procedure of network slice admission control for number of UEs in accordance with embodiments of the present disclosure. In an example, if the AMF is not aware of the NSACF with which to communicate, the AMF may perform NSACF discovery. In an example, the AMF may trigger the number of UEs per network slice availability check and update procedure to update the number of UEs registered with a network slice when a network slice subject to NSAC is included in the Allowed NSSAI (e.g., the AMF may request to register the UE with the S-NSSAI) or removed from the Allowed NSSAI (e.g., the AMF requests to de-register the UE from the S-NSSAI) for a UE. The trigger event at the AMF also includes the change of Allowed NSSAI in case of inter-AMF mobility. The procedure may be triggered in at least one of the following cases:
Registration type indicating dual steer, for example, the UE indicates the dual steer capability indication in RRC message, or NAS message.
NAS message comprises an indication of MA-PDU session. For example, NAS message indicates the registration is for UE with MA PDU session capability, registration message indicating that MA-PDU support, dual steer, and/or the like is required from the network.
At UE Registration procedure, (including Registration types of Initial Registration or Mobility Registration Update in inter-AMF mobility in CM-CONNECTED or CM-IDLE state):
before the Registration Accept if the EAC mode is active; or
after the Registration Accept message if the EAC mode is not active;
At UE Deregistration procedure, after the Deregistration procedure is completed;
At UE Configuration Update procedure (which may result from NSSAA procedure or subscribed S-NSSAI change):
before the UE Configuration Update message if the EAC mode is active and the update flag is to increase; or
after the UE Configuration Update message if the EAC mode is active and the update flag is to decrease; or
after the UE Configuration Update message if the EAC mode is not active.

In an example, depending on the deployment, there may be different NSACF for different S-NSSAI subject to NSAC and hence, during the registration, the AMF may trigger the number of UEs per network slice availability check and update procedure to multiple NSACFs.

In an example, the AMF may send Nnsacf_NSAC_NumOfUEsUpdate_Request message to the NSACF. The AMF may include in the message the UE ID, Access Type to which the Allowed NSSAI is applied, the S-NSSAI(s), the NF ID and the update flag which indicates whether the number of UEs registered with the S-NSSAI(s) is to be increased when the UE has gained registration to network slice(s) subject to NSAC or the number of UEs registered with the S-NSSAI(s) is to be decreased when the UE has deregistered from S-NSSAI(s) or could not renew its registration to an S-NSSAI subject to NSAC.

In an example, for access of the UE to register for dual steer mode, the following may be performed. When the UE access the network, the UE may send a NAS message to the AMF as described in an example embodiment. In an example, the NAS message may comprise the SNSSAI, an indication that the access of the UE is for dual steer mode or dual steer capability, dual steer functionality, and/or the like. In an example, the RAN node may receive the RRC message from the UE. In an example, the UE may send to the RAN node a message comprising an AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [Paging Subgrouping Support Indication], [UE Policy Container (the list of PSIs, indication of UE support for ANDSP, the operating system identifier, Indication of URSP Provisioning Support in EPS, UE capability of supporting to report URSP rule enforcement to network)] and [UE Radio Capability ID], [Release Request indication], [Paging Restriction Information], PEI, [PLMN with Disaster Condition], [Requested Periodic Update time], [Unavailability Period Duration])). In an example, in the case of NG-RAN, the AN parameters may comprise e.g., 5G-S-TMSI or GUAMI, the Selected PLMN ID (or PLMN ID and NID, and NSSAI information, the AN parameters may comprise Establishment cause. The Establishment cause may provide the reason for requesting the establishment of an RRC connection. For example, the establishment cause may be dual steer (dualsteer).

In an example, the RAN node may send an N2 message to the AMF. In an example, the N2 message may comprise N2 parameters, the Registration Request (as described the message sent from the UE to the RAN node) and [LTE-M Indication]. In an example, when NG-RAN is used, the N2 parameters may comprise the Selected PLMN ID (or PLMN ID and NID, Location Information and Cell Identity related to the cell in which the UE is camping, UE Context Request which indicates that a UE context including security information needs to be setup at the NG-RAN. When NG-RAN is used, the N2 parameters may comprise the Establishment cause and IAB-Indication if the indication is received in AN parameters. In an example, the RAT type the UE is using may be determined by the AMF. In an example, based on the determining, the AMF may determine that an access of the UE for dual steer connectivity may be associated with the RAT type. In an example, the AMF may store the RAT type in the UE context. If the AMF receives the LTE M indication, then it considers that the RAT Type is LTE-M and stores the LTE-M Indication in UE Context. If the UE has included a UE Radio Capability ID and the AMF supports RACS, the AMF may store the Radio Capability ID in UE context. In an example, the UE capability ID may be associated with dual steer (dualsteer) capability support. In an example, for NR satellite access, the AMF may verify the UE location and determine whether the PLMN is allowed to operate at the UE location. If the UE receives a Registration Reject message with cause value indicating that the PLMN is not allowed to operate at the present UE location, the UE may attempt to select a PLMN.

In an example, the AMF may receive one or more messages from the UE during the registration for dual steer. In an example, the AMF may determine one or more RAT types associated with one or more accesses of the UE to network for dualsteer. In an example, a first access leg may be associated with a first access type (e.g., 3GPP access type) and a first RAT type. In an example, a second access leg may be associated with the first RAT type and a second RAT type. In an example, the access legs may be associated with access of the UE for dual steer connectivity, or MA-PDU sessions of the UE. In an example, an access leg of the MA-PDU session (e.g., the first access leg) may employ or utilize the first access type and the first RAT type. In an example, an access leg of the MA-PDU session (e.g., the second access leg) may employ the first access type and the second RAT type. In an example, a PDU session, a connection of the wireless device with the network, a registration of the wireless device with the network, may be via the first access being of the first access type and the first RAT type and via the first access type and the second RAT type. In an example, the wireless device may be connected (e.g., registered, having PDU session, having MA-PDU session, and/or the like) to the network via the NR RAT type of the 3GPP access type and via satellite connection, satellite access, and/or the like.

In an example the AMF may send the Nnsacf_NSAC_NumOfUEsUpdate_Request message to the NSACF wherein the message may comprise the indication that the access of the UE is for dual steer mode or dual steer capability, dual steer functionality, information of the first access leg (e.g., comprising the first access type and the first RAT type), information of the second access leg (e.g., comprising the first access type and the second RAT type), the S-NSSAI(s), the NF ID and the update flag which indicates whether the number of UEs registered with the S-NSSAI(s) is to be increased when the UE has gained registration to network slice(s) subject to NSAC or the number of UEs registered with the S-NSSAI(s) is to be decreased when the UE has deregistered from S-NSSAI(s) or could not renew its registration to an S-NSSAI subject to NSAC.

In an example, if this is the first time to perform NSAC procedure for the S-NSSAI towards the NSACF, the AMF may include notification endpoint for EAC Notification to implicitly subscribe the EAC notification for the S-NSSAI from the NSACF.

In an example, the NSACF may determine whether the dual steer access as indicated by the AMF is configured for the NSAC based on its configuration. In an example, the NSACF may determine whether the Access Type provided by the AMF is configured for the NSAC based on its configuration. In an example, the NSACF may determine whether the provided information of the first access and the second access or the dual steer functionality support is configured for the NSAC, and the NSACF may determine to accept or reject the request from the AMF without increasing or decreasing the number of UEs. In an example, if the Access Type is not configured for the NSAC, the NSACF may accept the request from the AMF without increasing or decreasing the number of UEs. In an example, if the provided information of the first access and the second access or the dual steer functionality support as indicated by the AMF is configured for the NSAC, the NSACF updates the current number of UEs registered for the S-NSSAI, e.g., increases or decrease the number of UEs registered per network slice and per access leg information (e.g., RAT type) based on the information provided by the AMF in the update flag parameter. If the Access Type and RAT type is configured for the NSAC, the NSACF updates the current number of UEs registered for the S-NSSAI, e.g., increases or decrease the number of UEs registered per network slice based on the information provided by the AMF in the update flag parameter.

In an example, if the update flag parameter from the AMF indicates increase (for example, increase in the number of UEs registered per network slice), the following may apply. If the UE ID is already in the list of UEs registered with the network slice and associated the access type and the RAT type, the current number of UEs is not increased as the UE has already been counted as registered with the network slice. In an example, if the UE ID does not exist or the entry associated the access type and the RAT type does not exist, the NSACF may create a new entry associated with this new update and may also maintain the old entry associated with previous update. The multiple entries for the same UE ID in the NSACF are differentiated based on the NF ID of the NF sending the update request. The NSACF may remove the entry associated with the NF ID upon reception of a request having update flag indicating decrease (for example, decrease in the number of UEs registered per network slice).

In an example, the use case of having two or more entries in the NSACF for the same UE may happen when the UE access an overlay network via multiple underlay networks, or the UE has a multiaccess PDU session (MA-PDU session) having one access leg directly with the overlay network and another access leg via the underlay network.

In an example, the use case of having two or more entries in the NSACF for the same UE may happen during (a) inter-AMF mobility when the new AMF request update to the NSACF before the old AMF sends request to deregister the UE; or (b) PDN connections establishment in the EPC when multiple SMF +PGW-Cs (e.g., used for different PDN connections associated with the same S-NSSAI) send update requests for maximum number of UEs to the NSACF.

In an example, if the update flag parameter from the AMF indicates increase (for example, increase in the number of UEs registered per network slice), the following may apply. If the UE ID is not in the list of UE IDs registered with the network slice and the maximum number of UEs registered with the network slice has not been reached yet, the NSACF adds the UE ID in the list of UEs registered with the network slice as a new entry associated with this new update and increases the current number of the UEs registered with the network slice via the underlay network with underlay network ID.

In an example, if the UE ID is not in the list of UEs registered with that S-NSSAI and the maximum number of UEs accessing the network with dual steer function, or the access type and the RAT type for that S-NSSAI has already been reached, then the NSACF returns a result parameter indicating that the maximum number of UEs registered with the network slice has been reached.

In an example, if the UE ID is not in the list of UEs registered with that S-NSSAI and the maximum number of UEs accessing the overlay network via the underlay network with underlay network ID for that S-NSSAI has already been reached, then the NSACF returns a result parameter indicating that the maximum number of UEs registered via the underlay network with underlay network ID with the network slice has been reached.

In an example, if the update flag parameter from the AMF indicates decrease (for example, decrease in the number of UEs registered per network slice) and if there is only one entry associated with the UE ID, the NSACF removes the UE ID from the list of UEs registered with the network slice for each of the S-NSSAI(s) indicated in the request from the AMF and also the NSACF decreases the number of UEs per network slice that is maintained by the NSACF for each of these network slices. If there are multiple entries associated with the UE ID, the NSACF removes the entry associated with the NF ID, and the access leg of the UE with dual steer connection. In an example, the UE ID may be kept in the list of UEs registered with the S-NSSAI.

In an example, the NSACF may take an extended access indication, underlay network ID, access type, and/or the like into account for increasing and decreasing the number of UEs per network slice.

In an example, the NSACF may store the notification endpoint for EAC Notification associated with the S-NSSAI if it is received from the AMF. The NSACF may use this AMF notification endpoint to update the EAC mode.

In an example embodiment, the NSACF may return the Nnsacf_NSAC_NumOfUEsUpdate_Response message including result indication per S-NSSAI. The Result indication may include either ‘maximum number of UEs registered with the network slice reached’ or ‘maximum number of UEs registered with the network slice not reached’. In an example the Nnsacf_NSAC_NumOfUEsUpdate_Response message may comprise the access leg information e.g., the information of the first access leg (e.g., comprising the first access type and the first RAT type), information of the second access leg (e.g., comprising the first access type and the second RAT type), dual steer indication, extended access indication, the extended access type, the underlay network ID, and/or the like.

In an example, at UE registration procedure, if some of the S-NSSAIs reached the maximum number of UEs per S-NSSAI, the AMF may send a registration accept message to the UE in which the AMF may include the rejected S-NSSAI(s) in the rejected NSSAI list for which the NSACF has indicated that the maximum number of UEs per network slice has been reached and for each rejected S-NSSAI the AMF includes a reject cause set to ‘maximum number of UEs per network slice reached’, the dual steer indication, the access leg information associated with the rejection e.g., the information of the first access leg (e.g., comprising the first access type and the first RAT type), information of the second access leg (e.g., comprising the first access type and the second RAT type) and a back-off timer. In an example, the rejection cause may indicate ‘maximum number of UEs per network slice reached for extended access of the UE via the underlay network’, or ‘maximum number of UEs per network slice reached via underlay network with underlay network ID’.

In an example, when for all the requested S-NSSAI(s) the NSACF returned the maximum number of UEs per network slice has been reached and if one or more subscribed S-NSSAIs are marked as default in the subscription data and not subject to NSAC, the AMF may determine or decide to include these default subscribed S-NSSAIs in the allowed NSSAI. In an example, the AMF may reject the UE request for registration. In an example, in the registration reject message, the AMF may include the rejected S-NSSAI(s) in the rejected NSSAI parameter and for each rejected S-NSSAI the AMF includes a reject cause to indicate that the maximum number of UEs per network slice has been reached and a back-off timer. In an example, the registration reject message may comprise a reject cause to indicate that the maximum number of UEs per network slice has been reached for dual steer connectivity. In an example, the registration reject message may comprise the dual steer indication, the access leg information associated with the rejection e.g., the information of the first access leg (e.g., comprising the first access type and the first RAT type), information of the second access leg (e.g., comprising the first access type and the second RAT type) the back-off timer, and/or the like.

In an example, if the UE is required to remain reachable at all times with at least one slice, at least one of the Subscribed S-NSSAIs may be marked as the default S-NSSAI which is not subject to NSAC. This will ensure the UE is able to access to services even when maximum number of UEs per network slice has been reached.

In an example embodiment, configuration for early admission control (EAC) update procedure may be performed. The configuration for Early Admission Control (EAC) update procedure may indicate to the AMF the activation or the deactivation of the EAC mode for the S-NSSAI subject to NSAC. EAC mode means that the AMF is required to perform the number of UEs per network slice availability check and update procedure before the S-NSSAI subject to NSAC is included in the Allowed NSSAI and sent to the UE. EAC mode may be applicable in the AMF when the update flag is set to increase. In an example, the EAC activation may be performed for dual steer access or connections and may be based on the dual steer indication.

In an example, the AMF may subscribe to the EAC notification for the S-NSSAI for access of the UE via underlay network when it performs the first network slice availability check and update procedure for the S-NSSAI with the NSACF. The NSACF may send the EAC mode notification towards all notification endpoints associated with the S-NSSAI.

In an example, as depicted in FIG. 20, the number of UEs registered with a network slice subject to NSAC may cross a certain operator defined threshold. The NSACF may determine whether to activate or deactivate the EAC mode. In an example, the NSACF may trigger Nnsacf_NSAC_EACNotify operation including the S-NSSAI(s) for which the EAC mode is to be activated or deactivated and a EAC flag(s) set to activated if the number of UEs registered with the network slice is above certain threshold or set to deactivated if the number of the UEs registered with the network slice is below certain threshold which may be same or different with respect to the activation threshold. In an example, the NSACF may send to the AMF the Nnsacf_NSAC_EACNotify message comprising EAC flag being activated or deactivated, the dual steer indication, and/or the like. In an example, the Nnsacf_NSAC_EACNotify message may be employed to activate or deactivate EAC for S-NSSAI(s) used by connections of UEs with dual steer connection or functionality.

In an example, the AMF may employ or use the EAC flag to determine or decide when to trigger the number of UEs per network slice availability check and update procedure so that delays to the registration procedure and impact to the already allowed network slices are avoided. For example, if the Nnsacf_NSAC_EACNotify message indicates the dual steer function, MA PDU support, ATSSS support, and/or the like, the AMF may trigger the number of UEs per network slice availability check and update procedure when a request is received from UE with the indication of dual steer functionality.

In an example, if the EAC flag indicates EAC mode activated, the AMF may trigger the number of UEs per network slice availability check and update procedure before the registration accept step of the registration procedure or before the UE configuration update message.

If the EAC flag indicates EAC mode deactivated, the AMF may trigger the number of UEs per network slice availability check and update procedure after registration accept step of the registration procedure or after the UE configuration update.

In an example embodiment, the first access leg of the MA PDU session and the second access leg of the MA-PDU session may access different AMFs or same AMF.

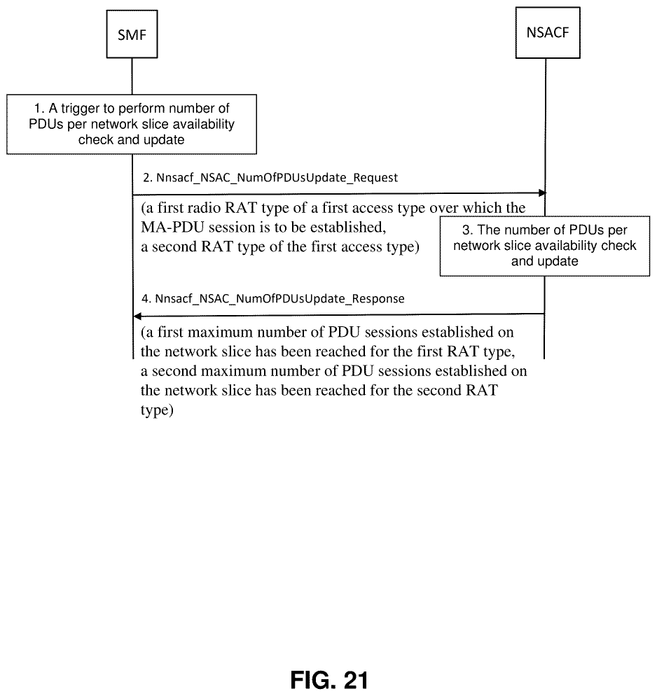

In an example, FIG. 21 may depict an example procedure of network slice admission control for number of PDU sessions in accordance with embodiments of the present disclosure. In an example, the number of PDU Sessions per network slice availability check and update procedure may be employed to update (e.g., increase or decrease) the number of PDU sessions established on S-NSSAI which is subject to NSAC. The SMF may be configured with the information indicating which network slice is subject to NSAC.

In an example, if the SMF is not aware of which NSACF to communicate, the SMF performs NSACF discovery and selection. The SMF anchoring the PDU session may trigger the Number of PDU Sessions per network slice availability check and update procedure for the network slices that are subject to NSAC at the beginning of a PDU session establishment procedure for new PDU Sessions to be established and as a step of successful PDU Session Release procedure.

In an example, the SMF may receive a NAS message from the UE that may comprise the S-NSSAI(s), the dual steer indication. In an example, the UE may send the NAS message to the AMF that may comprise the S-NSSAI(s), the dual steer indication. The AMF may send the NAS message to the SMF that may comprise the S-NSSAI(s), the dual steer indication, the access leg information e.g., the information of the first access leg (e.g., comprising the first access type and the first RAT type), information of the second access leg (e.g., comprising the first access type and the second RAT type). In an example, the NAS message may be a SM-NAS message. In an example, the NAS message may comprise the S-NSSAI(s), the dual steer indication, the access leg information e.g., the information of the first access leg (e.g., comprising the first access type and the first RAT type), information of the second access leg (e.g., comprising the first access type and the second RAT type), and/or the like. In an example, when the SMF anchoring the PDU session receives the NAS message or the PDU session request from the UE, the SMF may send Nnsacf_NSAC_NumOfPDUsUpdate_Request message to the NSACF. In an example, the Nnsacf_NSAC_NumOfPDUsUpdate_Request message may comprise at least one of the S-NSSAI(s), the dual steer indication, the access leg information e.g., the information of the first access leg (e.g., comprising the first access type and the first RAT type), information of the second access leg (e.g., comprising the first access type and the second RAT type), and/or the like. In an example, the SMF may include in the message the UE-ID, the PDU session ID, S-NSSAI for which the number of PDU Sessions per network slice update is required, Access Type and the update flag. In an example, the update flag may include one of the following values:
‘increase’ which indicates that the number of PDUs established on the S-NSSAI is to be increased when the procedure is triggered at the beginning of PDU Session Establishment procedure or when a new user plane leg is to be established for an MA PDU Session;
‘decrease’ which indicates that the number of PDU Sessions on the S-NSSAI is to be decreased when the procedure is triggered at the end of PDU Sessions Release procedure or when an existing user plane leg is to be released for an MA PDU Session. In the case of a PDU Session Establishment failure, the anchor SMF may trigger another request to the NSACF with the update flag parameter equal to decrease in order to re-adjust back the PDU Session counter in the NSACF; or
‘update’ which indicates that for existing PDU Session the Access Type is to be replaced with a new Access Type during inter access mobility.

In an example, for SSC mode 3 PDU session, the SMF of the new PDU Session may invoke the NSACF to increase the number of PDU Session and adds the new PDU session ID in the NSACF. When the old PDU session is released the SMF of the old PDU session invokes the NSACF to decrease the number of PDU Session and remove the old PDU session ID in the NSACF.

In an example, the NSACF may update the current number of PDU Sessions established via the first access leg (e.g., via the first access type and the first RAT type), and/or the second access leg (e.g., via the first access type and the second RAT type) on the S-NSSAI, e.g., increase or decrease the number of PDU Sessions per network slice based on the information provided by the anchor SMF in the update flag parameter. In an example, if the update flag parameter from the SMF anchoring the PDU session indicates increase value and the maximum number of PDU Sessions established on the S-NSSAI has already been reached, then the NSACF returns a result parameter indicating that the maximum number of PDU Sessions per network slice has been reached. In an example, the result parameter may indicate that the maximum number of PDU Sessions via the first access leg (e.g., comprising the first access type and the first RAT type), and/or the second access leg (e.g., comprising the first access type and the second RAT type) per network slice has been reached. If the maximum number of PDU Sessions established on the S-NSSAI has not been reached, the NSACF checks the UE ID. If the UE ID is located, the NSACF, stores the PDU Session ID, the information of the first access leg (e.g., comprising the first access type and the first RAT type), the information of the second access leg (e.g., comprising the first access type and the second RAT type), the Access Type and increases the number of PDU Sessions for that S-NSSAI for access via the first access leg and/or the second access leg. If the NSACF did not locate the UE ID, it creates an entry for the UE ID, stores the PDU Session ID, the information of the first access leg (e.g., comprising the first access type and the first RAT type), the information of the second access leg (e.g., comprising the first access type and the second RAT type), and Access Type for the single access PDU session and increases the number of PDU Sessions for that S-NSSAI. If the update flag parameter from the SMF anchoring the PDU session indicates decrease value, the current number of PDU Sessions per S-NSSAI, the NSACF locates the UE ID and decreases the number of PDU Sessions for that S-NSSAI and removes the related PDU Session ID entry. If the UE ID has no more PDU sessions, after the decrease, the NSACF removes the UE ID entry. In an example, if the update flag parameter from the SMF anchoring the PDU session indicates update value, the NSACF locates the existing entry with UE ID and PDU Session ID and replaces the information of the first access leg (e.g., comprising the first access type and the first RAT type), the information of the second access leg (e.g., comprising the first access type and the second RAT type), Access Type in the existing entry. In an example, the NSACF may take the extended access indication, the extended access via the underlay network, underlay network ID, and/or the like parameter into account for increasing and decreasing the number of PDU Sessions per S-NSSAI. In an example, the NSACF may take the Access Type parameter into account for increasing and decreasing the number of PDU Sessions per S-NSSAI. For MA PDU Session, if the SMF received information that the UE is registered over both accesses, the SMF provides multiple Access Types to the NSACF. If the NSACF receives a request containing multiple Access Types, the NSACF provides a Result indication for each Access Type.

In an example, the NSACF may acknowledge the update to the anchor SMF with Nnsacf_NSAC_NumOfPDUsUpdate_Response message comprising a result indication, the access leg information associated with the rejection or acceptance e.g., the information of the first access leg (e.g., comprising the first access type and the first RAT type), information of the second access leg (e.g., comprising the first access type and the second RAT type), the back-off timer and the Access Type. If the NSACF returns a result indication including ‘maximum number of PDU Sessions per S-NSSAI reached’, the SMF rejects the PDU Session establishment request with reject cause set to ‘maximum number of PDU Sessions per S-NSSAI reached’, the S-NSSAI(s), the dual steer indication, the access leg information associated with the rejection e.g., the information of the first access leg (e.g., comprising the first access type and the first RAT type), information of the second access leg (e.g., comprising the first access type and the second RAT type), the back-off timer and the Access Type. In an example, the Nnsacf_NSAC_NumOfPDUsUpdate_Response message may comprise the underlay network ID, the extended access indication, the extended access via the underlay network indication, and/or the like. In an example, if result indication comprises indication that maximum number of PDU Sessions per S-NSSAI reached for access of the UE via the underlay access (e.g., extended access), the SMF may reject the PDU session establishment request with reject cause set to ‘maximum number of PDU Sessions per S-NSSAI reached for extended access via the underlay network’, the underlay network ID, the extended access indication, the extended access via the underlay network indication, the back-off timer and the access type.

In an example, for MA PDU session establishment, the NSACF may accept the MA PDU Session and may provide to the SMF a Result indicating ‘maximum number of PDU Sessions per S-NSSAI reached’ or ‘maximum number of PDU Sessions per S-NSSAI not reached’ associated with the S-NSSAI(s), the dual steer indication, the access leg information associated with the rejection e.g., the information of the first access leg (e.g., comprising the first access type and the first RAT type), information of the second access leg (e.g., comprising the first access type and the second RAT type), the underlay network access, underlay network ID, and the access type. If the NSACF indicates a failure that is associated with the access leg over which the UE sent the MA PDU Session Establishment Request, the SMF may send to the UE a PDU Session Establishment Reject with a result indication including ‘maximum number of PDU Sessions per S-NSSAI reached’, the back-off timer, the S-NSSAI(s), the dual steer indication, the access leg information (parameter) associated with the rejection e.g., the information of the first access leg (e.g., comprising the first access type and the first RAT type), information of the second access leg (e.g., comprising the first access type and the second RAT type), and the Access Type. When the SMF rejects the MA PDU Session, the SMF sets the access leg information (parameter) parameter as follows:
If the UE is registered via both access legs and:
If the NSACF indicates failure for both accesses, the access leg information (parameter) indicates both access legs;
If the NSACF indicates failure for the access over which the MA PDU Session Establishment Request is received, the access leg information (parameter) may indicate the access leg over which the MA PDU session request is received.

In an example, if the UE is registered in both accesses and the NSACF indicates failure for the access different from the access over which the MA PDU Session Establishment Request is received, the SMF may accept the MA PDU Session Request and may not provide back-off timer to the UE.
If the UE is registered via a single access, the access leg information (parameter) may indicate the access leg over which the MA PDU session request is received.

In an example embodiment, if the UE receives back-off timer, the UE may not request the establishment of user-plane resources on the restricted access leg until the back-off timer expires. The UE may request a PDU session via the access leg which is not restricted.

In an example, for MA PDU session release over single access leg, the NSACF may locate the existing entry with PDU Session ID and if found the entry with both access legs then it removes only the received access leg entry while keeping the PDU Session ID.

In an example, network slice admission control support for roaming by VPLMN may comprise the following. For NSAC for roaming UEs, a maximum number of allowed UEs per mapped S-NSSAI in HPLMN and/or a maximum number of allowed PDU Sessions in LBO mode per mapped S-NSSAI in HPLMN may be allocated to the VPLMN for each S-NSSAI in HPLMN and stored in one NSCAF in the VPLMN responsible for NSAC for the S-NSSAI in the HPLMN, subject to NSAC.

The maximum number of UEs registered with a network slice monitoring and enforcement is done in the VPLMN by the NSACF in the VPLMN with the following differences:
in the Nnsacf_NSAC_NumOfUEsUpdate_Request service operation the AMF may provide both the S-NSSAI in VPLMN and the corresponding mapped S-NSSAI in HPLMN to the NSACF in the VPLMN.
the NSACF in the VPLMN may perform NSAC for both the S-NSSAI in VPLMN and the corresponding mapped S-NSSAI in HPLMN based on the SLA between VPLMN and HPLMN.

In an example, for LBO, enforcement of the maximum number of PDU Sessions established for an S-NSSAI may be performed in the VPLMN by the NSACF in the VPLMN with the following differences:
in the Nnsacf_NSAC_NumOfPDUsUpdate_Request service operation the V-SMF may provide both the S-NSSAI in VPLMN and the corresponding mapped S-NSSAI in HPLMN to the NSACF in the VPLMN.
the NSACF in the VPLMN may perform NSAC for both the S-NSSAI in VPLMN and the corresponding mapped S-NSSAI in HPLMN based on the SLA between VPLMN and HPLMN.

In an example, for network slice admission control support for roaming by HPLMN, for PDU sessions in the home-routed roaming case, the SMF in HPLMN may perform NSAC for the S-NSSAI(s) subject to NSAC.

In an example embodiment, the NSACF may support the following services.

| Service | | Example |
|---|---|---|
| Name | Description | Consumer |
| Nnsacf_NSAC | This service allows NF | AMF, SMF |
| | service consumer | |
| | (e.g. AMF) to request | |
| | NSACF to perform per | |
| | slice admission control | |
| | for the number of | |
| | UEs/PDU sessions. | |
| Nnsacf_{—} | This service may provide | NEF, AF, NWDAF, |
| SliceEventExposure | event based notifications | DCCF |
| | to the NF service | |
| | consumer related | |
| | to the number of | |
| | UEs registered to | |
| | a network slice or | |
| | the number of PDU | |
| | Sessions established | |
| | to a network slice. | |

In an example, the following Table depicts corresponding APIs for NSACF services

| Service Name | Description | OpenAPI Specification File | apiName |
|---|---|---|---|
| Nnsacf_NSAC | per slice admission | TS29536_Nnsacf_NSAC.yaml | nnsacf-nsac |
| | control service to | | |
| | control the number of | | |
| | UEs/PDU sessions | | |
| Nnsacf_SliceEventExposure | Slice related event | TS29536_Nnsacf_SliceEventExposure.yaml | nnsacf-slice-ee |
| | subscription and | | |
| | notification | | |

In an example, the Nnsacf_NSAC service may providethe servicecapabilityforthe NF ServiceConsumer (e.g. AMF, SMF) to request admission control for UEs accessing a specific networkslice, orfor PDU sessions to be established to a specific network slice. The following are the key functionalities of this NF service:
Request the NSACF to control the number of UEs registered to a specific networkslice, e.g. perform availability check and updatethe numberof UEs registered to a specific network slice;
Request the NSACF to control the number of PDU session established to aspecific networkslice, e.g. perform availabilitycheck and update the numberof PDU sessions established to a specific network slice;
Notify the NF Service Consumer (e.g. AMF) ofthe activation/deactivation of EAC (EarlyAdmission Control) modeifor NSAC procedure;

In an example, the Nnsacf_NSAC service may support the following service operations.

| Service | | Operation | Example |
|---|---|---|---|
| Operations | Description | Semantics | Consumer(s) |
| NumOfUEsUpdate | Request the NSACF to | Request/ | AMF |
| | perform admission | Response | combined |
| | control to control the | | SMF + PGW-C |
| | number of UEs | | |
| | registered to a | | |
| | network slice. | | |
| NumOfPDUsUpdate | Request the NSACF to | Request/ | SMF, |
| | perform admission | Response | combined |
| | control to control | | SMF + PGW-C |
| | the number of PDU | | |
| | sessions established | | |
| | to a network slice. | | |
| EACNotify | Notify the NF Service | Subscribe/ | AMF |
| | Consumer of | Notify | |
| | the activation/ | | |
| | deactivation | | |
| | of EAC mode. | | |

In an example, when the UE connects to EPS and EPS counting is required for the S-NSSAI, the combined SMF +PGW-C may invoke the NumOfUEsUpdate and NumOfPDUsUpdate service operations in sequence. If the NumOfUEsUpdate returns failure, the combined SMF +PGW-C may not continue invoking the NumOfPDUsUpdate. If the NumOfPDUsUpate returns failure then the combined SMF +PGW-C may invoke the NumOfUEUpdate to decrease the UE count.

In an example, the related procedures using Nnsacf_NSAC service operations to request the NSACF to control the number of UEs registered to a specific network slice may be described as follows. The NumOfUEsUpdate service operation may be used by the NF Service Consumer (e.g. AMF, SMF, or combined SMF +PGW-C) to request the NSACF to control the number of UEs registered to a specific network slice, e.g., perform availability check and update the number of UEs registered to a network slice. It may be employed in the following procedures:
AMF initiated network slice admission control procedure related to control the number of UEs registered to a network slice.
SMF or combined SMF +PGW-C initiated network slice admission control procedure related to control the number of UEs registered to a network slice.

The operation may be used to update the number of existing registered UEs in the NSACF when NSAC is enabled or disabled for a slice which is already live in the network.

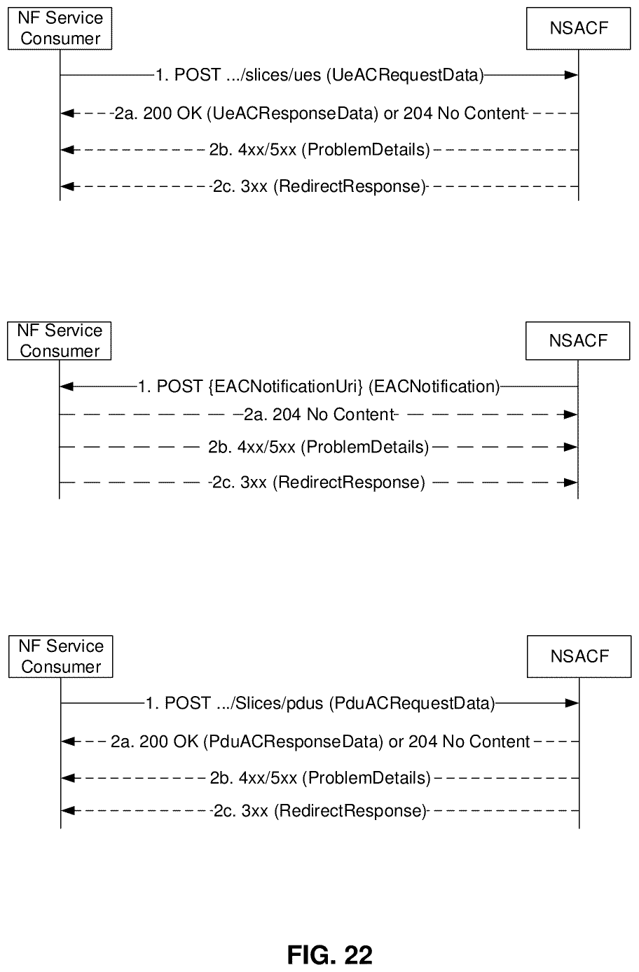

In an example, the NF Service Consumer (e.g., AMF, SMF, or combined SMF +PGW-C) may invoke the NumOfUEsUpdate service operation to request the NSACF to perform network slice admission control procedure related to the number of UEs, by using the HTTP POST method as depicted in FIG. 22.

In an example, the NF Service Consumer (e.g. AMF, SMF, or combined SMF +PGW-C) may send a POST request to the resource representing the network slice admission control related to the number of UEs (e.g., . . . /slices/ues) in the NSACF. The payload body of the POST request may comprise the input data structure (e.g., UeACRequestData) for network slice admission control, which may comprise the following information:
the dual steer indication,
the access leg information (parameter) e.g., the information of the first access leg (e.g., comprising the first access type and the first RAT type), information of the second access leg (e.g., comprising the first access type and the second RAT type).
In an example, if the UE accesses via two access legs of N3GPP, the access leg information (parameter) e.g., the information of the first access leg (e.g., comprising a second access type being N3GPP and the a RAT type of the N3GPP access), information of the second access leg (e.g., comprising the second access type and a second RAT type of the N3GPP).
In an example, if the UE is connected via two access leg that use two N31WF, the information of the first access leg may comprise an identifier of a first N31WF and the information of the second access leg may comprise an identifier of a second N31WF.
the extended access indication;
the identifier of the underlay network via which the UE is accessing the network (e.g., the overlay network);
an identifier of the N31WF through which the UE accesses the overlay network;
the identifier of the overlay network when the admission control is performed in the underlay network;
the SUPI(s) of the UE(s);
the access type, over which the UE registers to the network or deregisters from the network;
a list of S-NSSAIs which are subject to NSAC, and for each S-NSSAI an update flag indicates the operation to that S-NSSAI;
the NF Instance ID, identifying the requester NF.

In addition, the POST request may further comprise:
the EAC notification callback URI. The AMF may provide the EAC notification callback URI at the first interaction with the NSACF, or may provide an updated one in later interactions when it changes. If the EAC notification callback URI is set to null value by the AMF in later interactions, it means the AMF unsubscribes the EAC notification from the NSACF;
the additional access type, if the UE deregisters from the network over both 3GPP access and Non-3GPP access.

In an example, the update flag may be set to “INCREASE” for a UE to be registered to a specific slice, and may be set to “DECREASE” for a UE to be deregistered from a specific slice.

In an example, for NSAC of roaming UEs, the NF Service Consumer (e.g. AMF) may provide the S-NSSAI in serving PLMN, and the corresponding mapped S-NSSAI in home PLMN to the NSACF in serving PLMN.

In an example, when multiple S-NSSAIs are supported by a NSACF and multiple S-NSSAIs are required for NSAC for a given UE where EAC mode is active for at least one S-NSSAI, how the AMF triggers NSAC procedure to this NSACF may be implementation specific, e.g. the AMF triggers NSAC procedure for all these supported S-NSSAIs before the registration accept message or the UE configuration update message.

In an example, for each S-NSSAI included in UeACRequestData, the NSACF may perform the following actions:
if the update flag is set to “INCREASE”, the NSACF shall check whether the UE is already in the UE registration list stored in the NSACF and whether the total number of UEs to this slice will exceed the maximum number of UEs allowed to be registered to this slice:
if the UE ID is already recorded in the UE registration list but the requester NF is not recorded in the UE registration list, the NSACF shall create a new entry for the UE registration associated with the requester NF and shall also maintain the existing UE registration entries. The total number of UEs registered to this slice is not updated;
if the UE ID is not recorded in the UE registration list and the total number of UEs (including the UEs indicated in the request and the UEs already stored in the NSACF) does not exceed the maximum number of UEs allowed to be registered to this slice, the NSACF records the indicated UEs to the UE registration list stored in the NSACF, and updates the total number of UEs registered to this slice accordingly;
if the UE ID is not recorded in the UE registration list and if the total number of UEs will exceed the maximum number of UEs allowed to be registered to this slice, the NSACF shall not record the UE into the UE registration list stored in the NSACF, and shall not update the total number of UEs. Instead, the NSACF shall record this S-NSSAI in the failed list of S-NSSAI in the response message, together with an appropriate value of AcuFailureReason (e.g. “EXCEED_MAX_UE_NUM” as specified in clause 6.1.6.3.5);
if the update flag is set to “DECREASE” and if the UE is recorded in the UE registration list, the NSACF shall remove the indicated UEs from the UE registration list stored in the NSACF. If there are two or more UE registration entries associated with the UE ID, the NSACF shall only remove the entry associated with the requester NF. After removal, if a UE is no longer recorded in the UE registration list, the NSACF shall decrease the total number of UEs registered to this slice.
If the update flag is set to “DECREASE” and if the UE is not recorded in the UE registration list, the NSACF shall not decrease the total number of UEs registered to this slice and shall return successful handling for this UE registration.

In an example, for the MA-PDU session, the NSACF may be configured to perform per access leg (e.g., identified by a combination of access type and a RAT type, and/or the like) network slice admission control. In this case, the NSACF may check whether the access type and RAT type provided by the NF Service Consumer is configured for NSAC for the indicated S-NSSAI to control the number of UEs. If the access type and RAT type is not configured for NSAC for the indicated S-NSSAI, the NSACF may skip the above handling for increasing/decreasing the number of UEs and return successful for this S-NSSAI. If the access type and RAT type is configured for NSAC for the indicated S-NSSAI, the NSACF may perform the above handling taking the access type and RAT type into account and record/remove the UE registration associated with the access type. If the total number of UEs will exceed the maximum number of UEs allowed to be registered to this slice, the NSACF may record this S-NSSAI in the failed list of S-NSSAI in the response message, together with an appropriate value of AcuFailureReason (e.g. “EXCEED_MAX_UE_NUM” as specified in clause 6.1.6.3.5).

In an example, if the NSACF is not configured to perform per access leg network slice admission control, the NSACF may perform network slice admission control without taking access type and RAT type into account. For example, the NSACF may be configured with a total quota for the PLMN, but the network slice admission control is not specific to one access type and/or RAT type. The NSACF may record the access type(s) and RAT types associated with the UE registration. The NSACF may remove the corresponding UE registration entry when the UE deregisters from all access types.

In an example, the NSACF may be configured with a total quota for the underlay network (e.g., per underlay network basis quota), but the network slice admission control is not specific to one underlay network. The NSACF may record the underlay network ID associated with the UE registration. The NSACF may remove the corresponding UE registration entry when the UE deregisters from the overlay network via the underlay network.

In an example, the NSACF may be configured with a total quota for the overlay network (e.g., quota in the underlay network per overlay network), but the network slice admission control is not specific to one overlay network. The NSACF may record the overlay network ID associated with the UE registration. The NSACF may remove the corresponding UE registration entry when the UE deregisters from the underlay network.

In an example, if in above NSACF handling not all S-NSSAIs are successful, “200 OK” may be returned, with necessary response data indicating the failed S-NSSAI and the failure reason, e.g., “EXCEED_MAX_UE_NUM”. If in above NSACF handling all S-NSSAIs are successful, “204 No Content” may be returned which could represent the maximum number of UEs for the S-NSSAI not reached.

In an example, on failure, the appropriate HTTP status code (e.g. “403 Forbidden”) indicating the error may be returned. A ProblemDetails IE may be included in the payload body of POST response, with the “cause” attribute of ProblemDetails set to application error codes. On redirection, “307 Temporary Redirect” or “308 Permanent Redirect” may be returned. A RedirectResponse IE may be included in the payload body of POST response.

In an example, when the procedure is used to perform admission control for a number of UEs, when e.g., NSAC is enabled or disabled for an already live slice, then based on operator policy AMF may allow or disallow sessions for which NSACF returned a reject.

In an example, the EACNotify service operation may be used by the NSACF to inform the NF Service Consumer (e.g. AMF) of the activation/deactivation of EAC mode. It may be used in the NSACF initiated configuration on EAC mode procedure.

In an example, the NSACF initiated EAC mode configuration procedure may be as follows. The EACNotify service operation may be used by the NSACF to configure the EAC mode(s) for S-NSSAI(s) to the NF Service Consumer (e.g. AMF). The EACNotify service operation may be triggered when the NSACF decides to set the EAC mode for an S-NSSAI to “ACTIVE” if the number of UEs registered to an S-NSSAI is above certain threshold, or set the EAC mode for an S-NSSAI to “DEACTIVE” if the number of UEs registered to an S-NSSAI is below certain threshold. The activation threshold and the deactivation threshold may be same or different. If NF Service Consumer has implicitly subscribed to receive EAC notification, the NSACF may notify the NF Service Consumer (e.g. AMF) to configure the EAC mode by using the HTTP POST method as shown in FIG. 22.

In an example, the NSACF may send a POST request to the EAC Notification callback URI provided by the NF Service Consumer (e.g. AMF). The payload body of the POST request may comprise the notification payload (i.e. EACNotification), which may comprise the following information: the dual steer indication, the access leg information (parameter) e.g., the information of the first access leg (e.g., comprising the first access type and the first RAT type), information of the second access leg (e.g., comprising the first access type and the second RAT type), a RAT type, underlay network ID, overlay network ID, the EAC mode for each underlay network, the EAC mode for each overlay network, S-NSSAI(s), the EAC mode for each S-NSSAI, and/or the like.

In an example, the callback URI may be provided by the AMF in the first interaction with the NSACF, or in later interactions when the callback URI is changed. On success, “204 No Content” may be returned and the payload body of the POST response may be empty. On failure, one of the HTTP status codes may be returned. For a 4xx/5xx response, the message body may contain a ProblemDetails structure with the “cause” attribute set to one of the application errors.

In an example, the NumOfPDUsUpdate service operation may be used by the NF Service Consumer (e.g. SMF) to request the NSACF to control the number of PDU sessions registered to a specific slice, e.g., perform availability check and update the number of PDU sessions registered to a slice. It may be used in the following procedures:
SMF initiated network slice admission control procedure for controlling the number of PDU sessions registered to a network slice.
Combined SMF +PGW-C initiated network slice admission control procedure for controlling the number of PDU sessions registered to a network slice.

The operation may also be used to update the number of existing PDU Sessions in the NSACF when NSAC is enabled or disabled for a slice which is already live in the network.

In an example, network slice admission control for controlling the number of PDU sessions may be as follows. The NF Service Consumer (e.g. SMF, combined SMF +PGW-C) may invoke the NumOfPDUsUpdate service operation to request the NSACF to perform network slice admission control procedure related to the number of PDU sessions, by using the HTTP POST method as shown in FIG. 22.

In an example, the NF Service Consumer (e.g. SMF) may send a POST request to the resource representing the network slice admission control related to the number of PDU sessions (i.e. . . . /slices/pdus) in the NSACF. The payload body of the POST request may contain the input data structure (i.e. PduACRequestData) for network slice admission control, which may comprise the following information:
the dual steer indication;
the access leg information (parameter) e.g., the information of the first access leg (e.g., comprising the first access type and the first RAT type), information of the second access leg (e.g., comprising the first access type and the second RAT type),
In an example, if the UE accesses via two access legs of N3GPP, the access leg information (parameter) e.g., the information of the first access leg (e.g., comprising a second access type being N3GPP and the a RAT type of the N3GPP access), information of the second access leg (e.g., comprising the second access type and a second RAT type of the N3GPP).
In an example, if the UE is connected via two access leg that use two N31WF, the information of the first access leg may comprise an identifier of a first N31WF and the information of the second access leg may comprise an identifier of a second N31WF.
the extended access indication;
the identifier of the underlay network via which the UE is accessing the network (e.g., the overlay network);
an identifier of the N31WF through which the UE accesses the overlay network;
the identifier of the overlay network when the admission control is performed in the underlay network;
the SUPI of the UE;
the access type, over which the PDU session is to be established or released;
the PDU session ID(s);
a list of S-NSSAIs which are subject to NSAC, and for each S-NSSAI an update flag indicates the operation to that S-NSSAI.

In addition, the POST request may further comprise:
the NF Instance ID of the requester NF (i.e. SMF);
the PGW-C FQDN, if the request is sent by a combined SMF +PGW-C in EPS interworking case.
the additional access type, for an Multi-Access PDU session, if the PDU session is to be established over both 3GPP access and Non-3GPP access, or if the PDU session is to be released from both 3GPP access and Non-3GPP access.

The update flag within the PduACRequestData shall be set to the value as following:
“INCREASE” for a Single-Access PDU session which is to be established, or for an Multi-Access PDU session when new access leg(s) is to be established;
“DECREASE” for a Single-Access PDU session which is to be released, or for an Multi-Access PDU session when existing access leg(s) is to be removed;
“UPDATE” for a Single-Access PDU session when the access type is to be replaced with a new access type during inter access mobility.

For LBO cases, the NF Service Consumer in serving PLMN (e.g. vSMF) may provide the S-NSSAI in serving PLMN, and the corresponding mapped S-NSSAI in home PLMN to the NSACF in serving PLMN. For PDU sessions in the home-routed roaming case, the NF Service Consumer in home PLMN (e.g. hSMF) may provide S-NSSAI(s) in home PLMN to the NSACF in the home PLMN.

In an example, for each S-NSSAI included in PduACRequestData, the NSACF may perform the following actions:
if the update flag is set to “INCREASE”, the NSACF shall check whether the PDU session is already recorded in the PDU registration list in the NSACF and whether the total number of PDU sessions to this slice will exceed the maximum number of PDU sessions allowed to be registered to this slice:
if the PDU session (identified by the UE ID and the PDU session ID) is already recorded in the PDU registration list, the NSACF may skip recording this PDU session and may not increase the total number of PDU sessions established to this network slice;
if the PDU session is not recorded in the PDU registration list and the total number of PDU sessions (including the PDU session indicated in the request and the PDU sessions already stored in the NSACF) does not exceed the maximum number of PDU sessions allowed to be registered to this slice, the NSACF records the PDU session to the PDU registration list stored in the NSACF, and updates the total number of PDU sessions registered to this slice accordingly;
if the PDU session is not recorded in the PDU registration list and if the total number of PDU sessions will exceed the maximum number of PDU sessions allowed to be registered to this slice, the NSACF may not record the PDU session into the PDU registration list stored in the NSACF, and may not update the total number of PDU sessions. Instead, the NSACF may record this S-NSSAI in the failed list of S-NSSAI in the response message, together with an appropriate value of AcuFailureReason (e.g. “EXCEED_MAX_PDU_NUM”;
if the update flag is set to “DECREASE” and if the PDU session is recorded in the PDU registration list, the NSACF decreases the total number of PDU sessions registered to this slice, and removes the indicated PDU session from the PDU registration list stored in the NSACF.
If the update flag is set to “DECREASE” and if the PDU session is not recorded in the PDU registration list, the NSACF may not decrease the total number of PDU sessions registered to this slice and may return successful handling for this PDU registration.
If the update flag is set to “UPDATE”, the NSACF may locate the existing entry in the PDU registration list and update the access type associated to the PDU session to which indicated in the request message.

The NSACF may be configured to perform per access leg slice admission control, or slice admission control for dual steer connections. In this case, the NSACF may check whether the parameter (such as the dual steer indication, and access leg information, RAT types, and/or the like) provided by the NF Service Consumer is configured for NSAC for the indicated S-NSSAI to control the number of PDU sessions. If the parameter is not configured for NSAC for the indicated S-NSSAI, the NSACF may skip the above handling for increasing/decreasing the number of PDU sessions and may return successful for this S-NSSAI. If the parameter is configured for NSAC for the indicated S-NSSAI, the NSACF may perform the above handling taking the parameter into account. If the update flag is set to “UPDATE”, the NSACF may first increase the number of PDU sessions for the new access leg, and if successful then decrease the number of PDU sessions for the old access leg. If the total number of PDU sessions will exceed the maximum number of PDU sessions allowed to be registered to this slice, the AcuFailureReason may indicate the applied parameter (e.g. “EXCEED_MAX_PDU_NUM_DUALSTEER_ACCESS”, “EXCEED_MAX_PDU_NUM_MAPDU_ACCESS”, and/or the like).

The NSACF may be configured to perform per underlay access slice admission control, or per underlay network ID slice admission control. In this case, the NSACF may check whether the underlay network ID provided by the NF Service Consumer is configured for NSAC for the indicated S-NSSAI to control the number of PDU sessions. If the underlay network ID is not configured for NSAC for the indicated S-NSSAI, the NSACF may skip the above handling for increasing/decreasing the number of PDU sessions and may return successful for this S-NSSAI. If the underlay network ID is configured for NSAC for the indicated S-NSSAI, the NSACF may perform the above handling taking the underlay network ID into account. If the update flag is set to “UPDATE”, the NSACF may first increase the number of PDU sessions for the new underlay network ID, and if successful then decrease the number of PDU sessions for the old underlay network ID. If the total number of PDU sessions will exceed the maximum number of PDU sessions allowed to be registered to this slice, the AcuFailureReason may indicate the applied underlay network ID (e.g. “EXCEED_MAX_PDU_NUM_UNDERLAY_ACCESS” or “EXCEED_MAX_PDU_NUM_OVERLAY_ACCESS”.

The NSACF may be configured to perform per access type network slice admission control. In this case, the NSACF may check whether the access type provided by the NF Service Consumer is configured for NSAC for the indicated S-NSSAI to control the number of PDU sessions. If the access type is not configured for NSAC for the indicated S-NSSAI, the NSACF may skip the above handling for increasing/decreasing the number of PDU sessions and may return successful for this S-NSSAI. If the access type is configured for NSAC for the indicated S-NSSAI, the NSACF may perform the above handling taking the access type into account. If the update flag is set to “UPDATE”, the NSACF may first increase the number of PDU sessions for the new access type, and if successful then decrease the number of PDU sessions for the old access type. If the total number of PDU sessions will exceed the maximum number of PDU sessions allowed to be registered to this slice, the AcuFailureReason may indicate the applied access type (e.g. “EXCEED_MAX_PDU_NUM_3GPP” or “EXCEED_MAX_PDU_NUM_N3GPP”.

If the NSACF is not configured to perform per underlay network slice admission control, the NSACF may perform network slice admission control without taking underlay network into account. For example, the NSACF may be configured with a total quota for the underlay network, but the network slice admission control is not specific to one underlay network. The NSACF may record the underlay network (s) associated with the PDU registration. The NSACF may remove the PDU registration entry when the PDU session is released from the underlay network.

If the NSACF is not configured to perform per access type network slice admission control, the NSACF may perform network slice admission control without taking access type into account. For example, the NSACF is configured with a total quota for the PLMN, but the network slice admission control is not specific to one access type. The NSACF may record the access type(s) associated with the PDU registration. The NSACF may remove the PDU registration entry when the PDU session is released from all access types.

In an example, if in NSACF handling not all S-NSSAIs are successful, “200 OK” may be returned, with necessary response data, e.g. indicating the failed S-NSSAI(s) and underlay network ID. If in above NSACF handling all S-NSSAIS are successful, “204 No Content” may be returned.

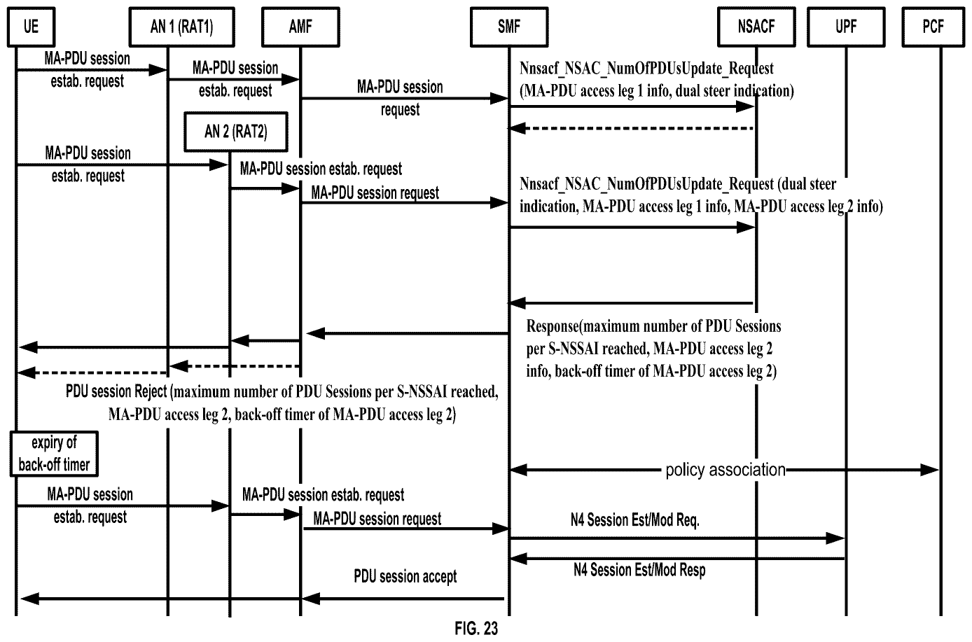

FIG. 23, illustrates an example PDU session establishment procedure in a network in accordance with embodiments of the present disclosure. The PDU session establishment procedure may be performed as depicted and described in FIG. 12. When a MA-PDU session is to be established, the PDU session establishment request message may be sent over the 3GPP access, underlay access or over the non-3GPP access. In an example, for the case of dual steer over 3GPP access, the MA-PDU session request message may be sent by the UE to the AMF and SMF via multiple (e.g., two) 3GPP access legs such as RAT 1 and RAT 2. In an example, that NAS message may comprise the dual steer (dualsteer) indication, dualsteer capability support, and/or the like. In an example, the UE may provide request type as “MA-PDU Request” in UL NAS Transport message and its dualsteer capabilities in PDU Session Establishment Request message. In an example, the UE may provide request type as “MA-PDU Request” in UL NAS Transport message and its ATSSS Capabilities in PDU Session Establishment Request message. The “MA-PDU Request” Request Type in the UL NAS Transport message may indicate to the network that this PDU Session Establishment Request is to establish a new MA-PDU Session and to apply the dualsteer capability/functionality, the ATSSS-LL functionality, or the MPTCP functionality, or all functionalities, for steering the traffic of this MA-PDU session. In an example, if the UE requests an S-NSSAI and the UE is registered over one or more accesses, it may request an S-NSSAI that is allowed on the one or more accesses.

The UE may send the MA-PDU session establishment request to an AMF via a base station. In an example, if the AMF supports MA-PDU sessions, then the AMF may select an SMF, which supports MA-PDU sessions. In an example, the AMF may select a SMF that supports dual steer capability. In an example, the AMF may inform the SMF that the request is for a MA-PDU Session by including “MA-PDU Request” indication and, in addition, it may indicate to SMF whether the UE is registered over one or more accesses. In an example, the AMF may indicate to the SMF that request is for dual steer (functionality) e.g., the message from the AMF to the SMF may comprise the dual steer indication. If the AMF determines that the UE is registered via one or more accesses but the requested S-NSSAI is not allowed on the one or more accesses, then the AMF may reject the MA-PDU session establishment. The AMF may reject the PDU Session Establishment request if the request is for a LADN. In an example, based on the request type and the dual steer indication, the AMF may accept the PDU session establishment request if the request is for a LADN.

In an example embodiment, the dual steer (dualsteer, dual-steer) capability may be a capability of the MA-PDU session, a capability of the network, a capability of the UE, and/or the like.

In an example, the SMF may retrieve, via session management subscription data, the information whether the MA-PDU session is allowed or not. In an example, if dynamic PCC is to be used for the MA-PDU Session, the SMF may sends an “MA-PDU Request” indication, and dual steer indication to the PCF in the SM Policy Control Create message the dual steer capabilities of the MA-PDU session, the ATSSS Capabilities of the MA-PDU session, and/or the like. The SMF may provide the currently used access type(s) and RAT type(s) to the PCF. The PCF may determine/decide whether the MA-PDU session is allowed or not based on operator policy and subscription data. In an example, the PCF may provide PCC rules that include MA-PDU session control information. In an example, from the received PCC rules, the SMF may derive/determine a) Dual steer rules, which may be sent to UE for controlling the traffic steering, switching and splitting in the uplink direction (b) ATSSS rules, which may be sent to UE for controlling the traffic steering, switching and splitting in the uplink direction, and (c) N4 rules associated with the dualsteer or ATSSS, which will be sent to UPF for controlling the traffic steering, switching and splitting in the downlink direction. If the UE indicates the support of dual steer, ATSSS, ATSSS-LL Capability, and/or the like, the SMF may derive the measurement assistance information (MAI).

In an example, the SMF may establish the user-plane resources over the one or more accesses such as 3GPP access as in dual steer function, N3GPP access, underlay access, and/or the like, or e.g., over the access where the PDU session establishment request was sent on.

In an example, the N4 rules derived by the SMF for the MA-PDU session may be sent to UPF and one or more N3 UL CN tunnels info are allocated by the UPF. If the dual steer or ATSSS LL functionality is supported for MA-PDU Session, the SMF may instruct the UPF to initiate performance measurement for this MA-PDU Session. If the MPTCP functionality is supported for the MA-PDU Session, the SMF may instruct the UPF to activate MPTCP functionality for this MA-PDU Session. In an example, the UPF may allocate addressing information for the Performance Measurement Function (PMF) in the UPF. If the UPF receives from the SMF a list of QoS flows over which access performance measurements may be performed, the UPF may allocate different UDP ports or different MAC addresses per QoS flow per access and/or per RAT type or access network (AN) type. In an example, the UPF may send the addressing information for the PMF in the UPF to the SMF. If UDP ports or MAC addresses are allocated per QoS flow and per access and/or RAT type (AN type), the UPF may send the PMF IP address information and UDP ports with the related QFI to the SMF in the case of IP PDU sessions and sends the MAC addresses with the related QFI to the SMF in the case of Ethernet PDU sessions.

In an example, if the message from the SMF instructs the UPF to activate MPTCP functionality, the UPF may allocate the UE link-specific multipath addresses/prefixes. In an example, the UPF may send the link-specific multipath addresses/prefixes and MPTCP proxy information to the SMF. In an example, for the MA-PDU session, the SMF may include an MA-PDU session accepted indication in the Namf_Communication_N1N2MessageTransfer message to the AMF and indicates to AMF that the N2 SM Information included in this message should be sent over 3GPP access. The AMF may mark the PDU session as MA-PDU session based on the received MA-PDU session accepted indication.

In an example, the UE may receive a PDU session establishment accept message, which indicates to UE that the requested MA-PDU session was successfully established. This message includes the ATSSS rules for the MA-PDU session, which were derived by SMF. If the ATSSS-LL functionality is supported for the PDU Session, the SMF may include the addressing information of PMF in the UPF into the measurement assistance information (MAI). If the MPTCP functionality is supported for the MA-PDU Session, the SMF may include the link-specific multipath addresses/prefixes of the UE and the MPTCP proxy information.

In an example, during the establishment of the MA-PDU session, the SMF may receive from the AMF, the dual steer indication, the access leg information (parameter) e.g., the information of the first access leg (e.g., comprising the first access type and the first RAT type), information of the second access leg (e.g., comprising the first access type and the second RAT type), a RAT type, the S-NSSAI(s), and/or the like.

In an example, when the SMF anchoring the PDU session receives the NAS message or the PDU session request from the UE or from the AMF, the SMF may send Nnsacf_NSAC_NumOfPDUsUpdate_Request message to the NSACF to perform network slice admission control for number of PDU sessions for dual steer MA-PDU session of the UE. In an example, the Nnsacf_NSAC_NumOfPDUsUpdate_Request message may comprise at least one of the S-NSSAI(s), the dual steer indication, the access leg information e.g., the information of the first access leg (e.g., comprising the first access type and the first RAT type), information of the second access leg (e.g., comprising the first access type and the second RAT type), and/or the like. In an example, the SMF may include in the message the UE-ID, the PDU session ID, MA-PDU session ID, S-NSSAI(s) for which the number of PDU Sessions per network slice update is required, Access Type, RAT type and the update flag. In an example, the update flag may include increase, decrease, or update as described in an example embodiment. In an example, the SMF may transmit the information of the first access leg and the information of the second access leg. In an example the SMF may transmit the information of the first access leg and the information of the second access leg separately. When the SMF sends the information of the first access leg, and the dual steer (capability) indication, the NSACF may accept the request (or does not provide any response) and wait for receiving the information of the second access leg to make an admission decision.

In an example, the NSACF may acknowledge the update to the anchor SMF with Nnsacf_NSAC_NumOfPDUsUpdate_Response message including a result indication. If the NSACF returns a result indication including ‘maximum number of PDU Sessions per S-NSSAI reached’, the SMF rejects the PDU Session establishment request with reject cause set to ‘maximum number of PDU Sessions per S-NSSAI reached’, the S-NSSAI(s), the dual steer indication, the access leg information associated with the rejection e.g., the information of the first access leg (e.g., comprising the first access type and the first RAT type), information of the second access leg (e.g., comprising the first access type and the second RAT type), the back-off timer and the Access Type. In an example, the Nnsacf_NSAC_NumOfPDUsUpdate_Response message may comprise the access leg information associated with the rejection e.g., the information of the first access leg (e.g., comprising the first access type and the first RAT type), information of the second access leg (e.g., comprising the first access type and the second RAT type), the back-off timer and the access type, RAT type the underlay network ID, the extended access indication, the extended access via the underlay network indication, and/or the like. In an example, if result indication comprises indication that maximum number of PDU Sessions per S-NSSAI reached for access of the UE for dual steer capable MA-PDU session, the SMF may reject the PDU session establishment request with reject cause set to ‘maximum number of PDU Sessions per S-NSSAI reached for the dual steer connection of the UE or MA-PDU session, the back-off timer and the access type.

In an example, for MA PDU session establishment, the NSACF may accept the MA PDU Session and may provide to the SMF a result indicating ‘maximum number of PDU Sessions per S-NSSAI reached’ or ‘maximum number of PDU Sessions per S-NSSAI not reached’ associated with the S-NSSAI(s), the dual steer indication, the access leg information associated with the rejection or acceptance e.g., the information of the first access leg (e.g., comprising the first access type and the first RAT type), information of the second access leg (e.g., comprising the first access type and the second RAT type), the underlay network access, underlay network ID, the RAT type, and the access type. If the NSACF indicates a failure that is associated with the access leg over which the UE sent the MA PDU Session Establishment request, the SMF may send to the UE a PDU session establishment response (reject or accept) with a result indication including ‘maximum number of PDU Sessions per S-NSSAI reached’, the back-off timer, the S-NSSAI(s), the dual steer indication, the access leg information (parameter) associated with the rejection e.g., the information of the first access leg (e.g., comprising the first access type and the first RAT type), information of the second access leg (e.g., comprising the first access type and the second RAT type), and the access type. When the SMF rejects the MA PDU Session, the SMF may set the access leg information (parameter) parameter as follows:
If the UE is registered via both access legs and:
If the NSACF indicates failure for both accesses, the access leg information (parameter) indicates both access legs;
If the NSACF indicates failure for the access over which the MA PDU Session Establishment Request is received, the access leg information (parameter) may indicate the access leg over which the MA PDU session request is received.

In an example, if the UE is registered in both accesses and the NSACF indicates failure for the access different from the access over which the MA PDU Session Establishment request is received, the SMF may accept the MA PDU session request and may not provide back-off timer to the UE.
If the UE is registered via a single access, the access leg information (parameter) may indicate the access leg over which the MA PDU session request is received.

In an example embodiment, if the UE receives back-off timer, the UE may not request the establishment of user-plane resources on the restricted access leg until the back-off timer expires. The UE may request a PDU session via the access leg which is not restricted.

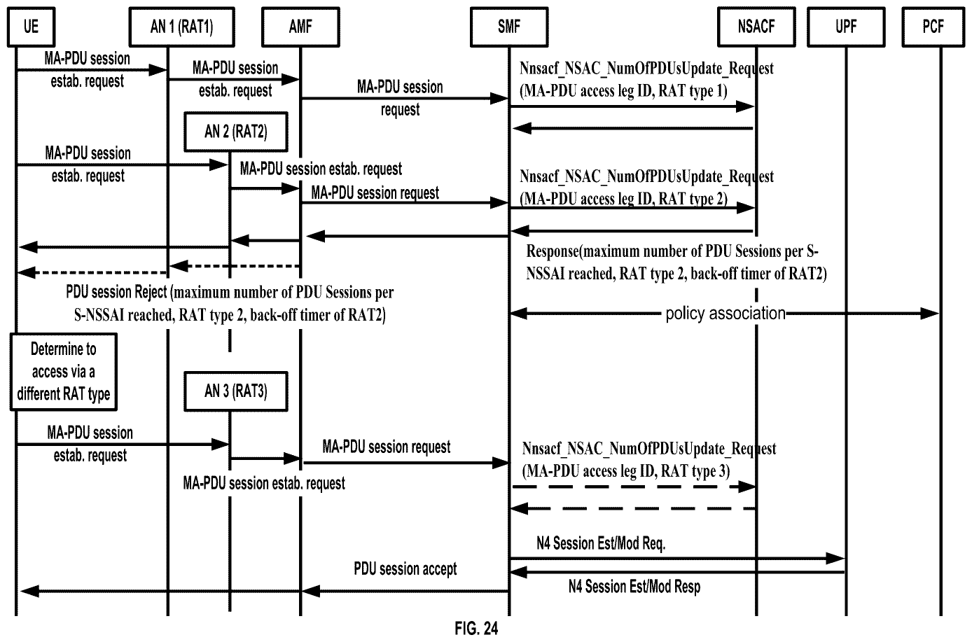

FIG. 24, illustrates an example PDU session establishment procedure (e.g., MA PDU session) in a network in accordance with embodiments of the present disclosure. The PDU session establishment procedure (may be performed for establishment of MA-PDU session) as depicted and described in example embodiments of the present disclosure. In an example, when the UE received a response from the AMF or the SMF indicating the result of the MA-PDU session establishment for dual steer functionality, the UE may receive the back-off timer, the dual steer indication, the access leg information (parameter) associated with the rejection e.g., the information of the first access leg (e.g., comprising the first access type and the first RAT type), information of the second access leg (e.g., comprising the first access type and the second RAT type). In an example, the UE may employ the information received from the SMF or the AMF to determine a RAT type or access leg information that is restricted due to admission control decisions. In an example, the access leg information may be identified or mapped to a RAT type, an identifier of a base station, a cell of the base station, NG-Ran ID, and/or the like. In an example, embodiment, the UE may determine to attempt access with establishment of the MA PDU session access leg via a third (different) RAT type of the first access type (e.g., 3GPP access) or as depicted in FIG. 24 as RAT 3. In an example, the UE may send an uplink NAS message comprising the dual steer indication and the identifier of the PDU session or MA-PDU session to establish the second access leg of the MA-PDU session via the third RAT type. In an example, the UE may receive an acceptance or rejection of the request.

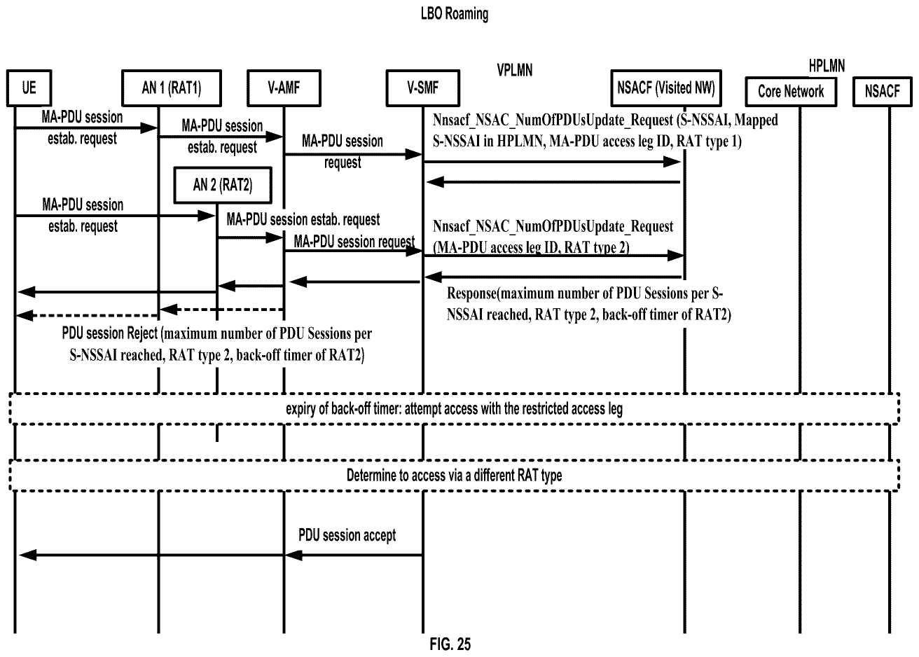

As depicted in FIG. 25 for LBO roaming, the NF Service Consumer in serving PLMN (e.g. vSMF) may provide the S-NSSAI in serving PLMN, and the corresponding mapped S-NSSAI in home PLMN to the NSACF in serving PLMN.

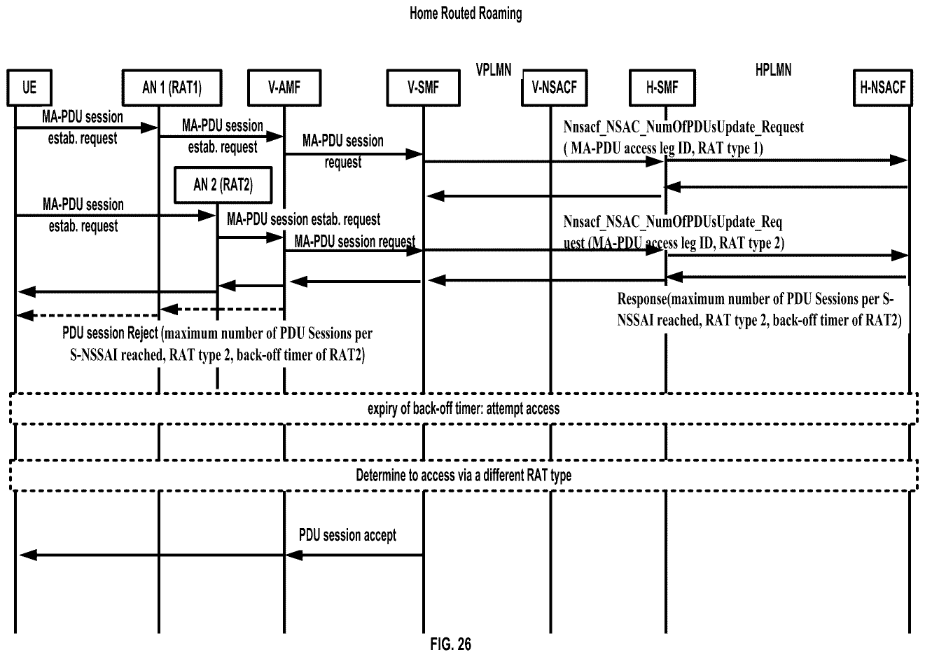

In an example as depicted in FIG. 26, for network slice admission control support for roaming by HPLMN, for PDU sessions in the home-routed roaming case, the SMF in HPLMN may perform NSAC for the S-NSSAI(s) subject to NSAC.

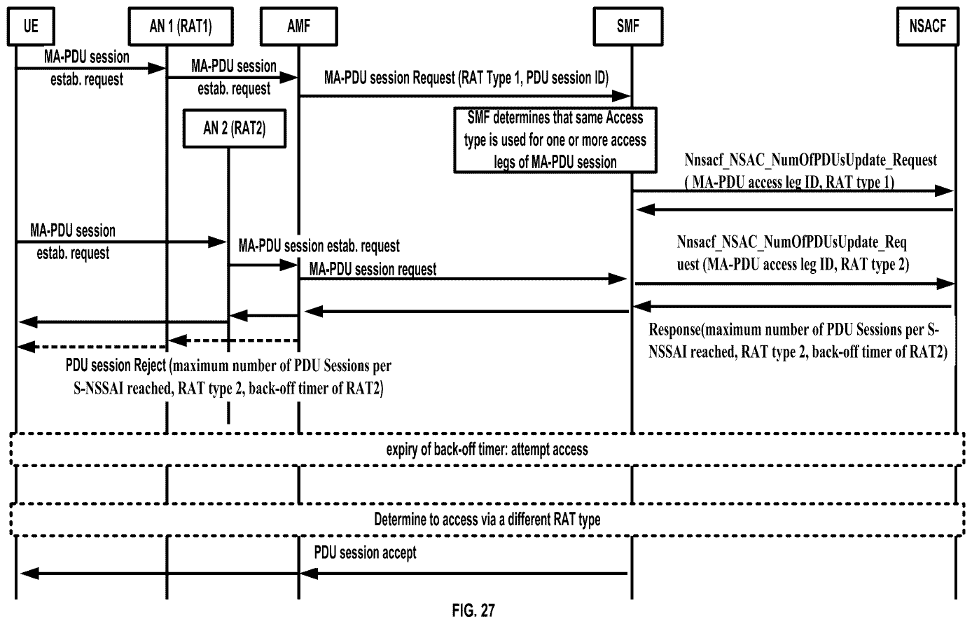

FIG. 27, illustrates an example PDU session establishment procedure (e.g., MA PDU session) in a network in accordance with embodiments of the present disclosure. In an example, when the SMF receives the NAS message via the AMF from the UE, that NAS message may comprise the dual steer indication and access leg information of access legs of the MA PDU session. In an example, when the SMF determines that the request is for dual steer or based on a determination that the access type of the two access legs of the MA PDU session are the same, the SMF may determine to indicate that RAT types associated with the access legs to the NSACF as described in example embodiments.

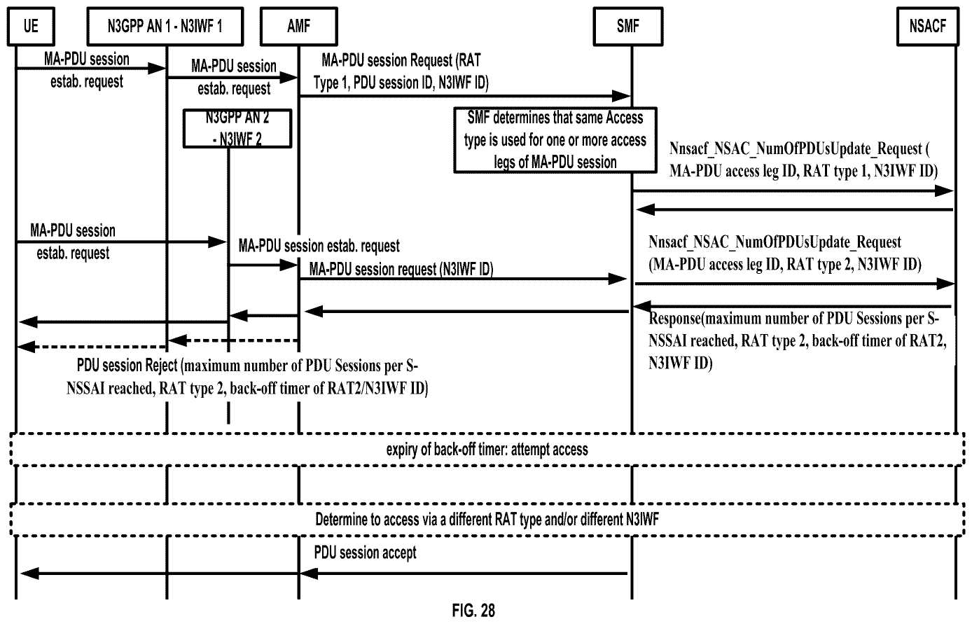

FIG. 28, illustrates an example PDU session establishment procedure (e.g., MA PDU session) in a network in accordance with embodiments of the present disclosure. In an example the dual steer MA-PDU session may be established via two access legs of N3GPP. In an example, when the SMF receives the NAS message via the AMF from the UE, that NAS message may comprise the dual steer indication and access leg information of access legs of the MA PDU session. In an example, the access leg information may comprise an identifier of a first N31WF associated with the first access leg, and an identifier of a second N31WF associated with the second access leg. In an example, when the SMF determines that the request is for dual steer or based on a determination that the access type of the two access legs of the MA PDU session are the same, the SMF may determine to indicate the access leg information associated with the access legs to the NSACF as described.

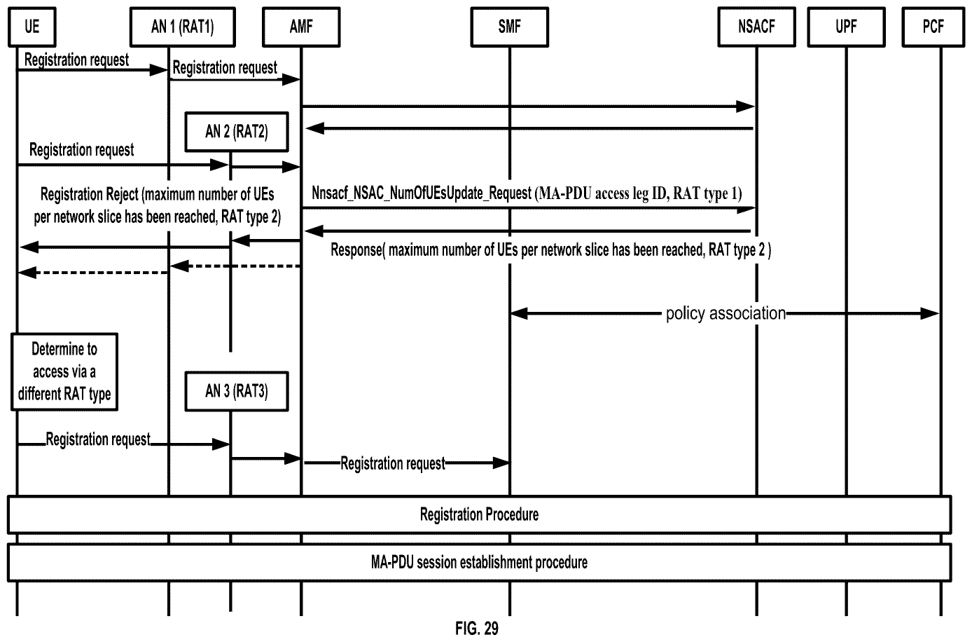

FIG. 29, illustrates an example registration procedure (e.g., for dual steer functionality, or MA PDU session connectivity) in a network in accordance with embodiments of the present disclosure. In an example, during the registration for dual steer functionality, the AMF may send Nnsacf_NSAC_NumOfUEsUpdate_Request message to the NSACF. The AMF may include in the message the UE ID, Access Type to which the Allowed NSSAI is applied, the S-NSSAI(s), the NF ID and the update flag which indicates whether the number of UEs registered with the S-NSSAI(s) is to be increased when the UE has gained registration to network slice(s) subject to NSAC or the number of UEs registered with the S-NSSAI(s) is to be decreased when the UE has deregistered from S-NSSAI(s) or could not renew its registration to an S-NSSAI subject to NSAC.

In an example, for access of the UE to register for dual steer mode, the following may be performed. When the UE access the network, the UE may send a NAS message to the AMF as described in an example embodiment. In an example, the NAS message may comprise the SNSSAI, an indication that the access of the UE is for dual steer mode or dual steer capability, dual steer functionality, and/or the like. In an example, the RAN node may receive the RRC message from the UE. In an example, the UE may send to the RAN node a message comprising an AN message (AN parameters, Registration Request (Registration type, SUCI or 5G-GUTI or PEI, [last visited TAI (if available)], Security parameters, [Requested NSSAI], [Mapping Of Requested NSSAI], [Default Configured NSSAI Indication], [UE Radio Capability Update], [UE MM Core Network Capability], [PDU Session status], [List Of PDU Sessions To Be Activated], [Follow-on request], [MICO mode preference], [Requested Active Time], [Requested DRX parameters for E-UTRA and NR], [Requested DRX parameters for NB-IoT], [extended idle mode DRX parameters], [LADN DNN(s) or Indicator Of Requesting LADN Information], [NAS message container], [Support for restriction of use of Enhanced Coverage], [Preferred Network Behaviour], [UE paging probability information], [Paging Subgrouping Support Indication], [UE Policy Container (the list of PSIs, indication of UE support for ANDSP, the operating system identifier, Indication of URSP Provisioning Support in EPS, UE capability of supporting to report URSP rule enforcement to network)] and [UE Radio Capability ID], [Release Request indication], [Paging Restriction Information], PEI, [PLMN with Disaster Condition], [Requested Periodic Update time], [Unavailability Period Duration])). In an example, in the case of NG-RAN, the AN parameters may comprise e.g., 5G-S-TMSI or GUAMI, the Selected PLMN ID (or PLMN ID and NID, and NSSAI information, the AN parameters may comprise Establishment cause. The Establishment cause may provide the reason for requesting the establishment of an RRC connection. For example, the establishment cause may be dual steer (dualsteer).

In an example, the RAN node may send an N2 message to the AMF. In an example, the N2 message may comprise the dual steer indication, N2 parameters, the Registration Request (as described the message sent from the UE to the RAN node) and [LTE-M Indication]. In an example, when NG-RAN is used, the N2 parameters may comprise the Selected PLMN ID (or PLMN ID and NID, Location Information and Cell Identity related to the cell in which the UE is camping, UE Context Request which indicates that a UE context including security information needs to be setup at the NG-RAN. When NG-RAN is used, the N2 parameters may comprise the Establishment cause and IAB-Indication if the indication is received in AN parameters. In an example, the RAT type the UE is using may be determined by the AMF. In an example, based on the determining, the AMF may determine that an access of the UE for dual steer connectivity may be associated with the RAT type. In an example, the AMF may store the RAT type in the UE context. If the AMF receives the LTE M indication, then it considers that the RAT Type is LTE-M and stores the LTE-M Indication in UE Context. If the UE has included a UE Radio Capability ID and the AMF supports RACS, the AMF may store the Radio Capability ID in UE context. In an example, the UE capability ID may be associated with dual steer (dualsteer) capability support. In an example, for NR satellite access, the AMF may verify the UE location and determine whether the PLMN is allowed to operate at the UE location. If the UE receives a Registration Reject message with cause value indicating that the PLMN is not allowed to operate at the present UE location, the UE may attempt to select a PLMN.

In an example, the AMF may receive one or more messages from the UE during the registration for dual steer connection that supports dual steer functionality. In an example, the AMF may determine one or more RAT types associated with one or more accesses of the UE to network for dual steer. In an example, a first access leg may be associated with a first access type (e.g., 3GPP access type) and a first RAT type. In an example, a second access leg may be associated with the first RAT type and a second RAT type. In an example, the access legs may be associated with access of the UE for dual steer connectivity, or MA-PDU sessions of the UE.

In an example the AMF may send the Nnsacf_NSAC_NumOfUEsUpdate_Request message to the NSACF wherein the message may comprise the indication that the access of the UE is for dual steer mode or dual steer capability, dual steer functionality, information of the first access leg (e.g., comprising the first access type and the first RAT type), information of the second access leg (e.g., comprising the first access type and the second RAT type), the S-NSSAI(s), the NF ID and the update flag which indicates whether the number of UEs registered with the S-NSSAI(s) is to be increased when the UE has gained registration to network slice(s) subject to NSAC or the number of UEs registered with the S-NSSAI(s) is to be decreased when the UE has deregistered from S-NSSAI(s) or could not renew its registration to an S-NSSAI subject to NSAC.

In an example, the NSACF may determine whether the dual steer access as indicated by the AMF is configured for the NSAC based on its configuration. In an example, the NSACF may determine whether the Access Type provided by the AMF is configured for the NSAC based on its configuration. In an example, the NSACF may determine whether the provided information of the first access and the second access or the dual steer functionality support is configured for the NSAC, and the NSACF may determine to accept or reject the request from the AMF without increasing or decreasing the number of UEs. In an example, if the Access Type is not configured for the NSAC, the NSACF may accept the request from the AMF without increasing or decreasing the number of UEs. In an example, if the provided information of the first access and the second access or the dual steer functionality support as indicated by the AMF is configured for the NSAC, the NSACF updates the current number of UEs registered for the S-NSSAI, e.g., increases or decrease the number of UEs registered per network slice and per access leg information (e.g., RAT type) based on the information provided by the AMF in the update flag parameter. If the Access Type and RAT type is configured for the NSAC, the NSACF updates the current number of UEs registered for the S-NSSAI, e.g., increases or decrease the number of UEs registered per network slice based on the information provided by the AMF in the update flag parameter indicating increase, decrease, or update as described in example embodiments.

In an example embodiment, the NSACF may return the Nnsacf_NSAC_NumOfUEsUpdate_Response message including result indication per S-NSSAI. The Result indication may include either ‘maximum number of UEs registered with the network slice reached’ or ‘maximum number of UEs registered with the network slice not reached’. In an example the Nnsacf_NSAC_NumOfUEsUpdate_Response message may comprise an indication of accept or reject, the access leg information associated with the indication e.g., the information of the first access leg (e.g., comprising the first access type and the first RAT type), information of the second access leg (e.g., comprising the first access type and the second RAT type), dual steer indication, extended access indication, the extended access type, the underlay network ID, and/or the like.

In an example, at UE registration procedure, if some of the S-NSSAIs reached the maximum number of UEs per S-NSSAI, the AMF may send a registration response or registration accept message to the UE in which the AMF may include the rejected S-NSSAI(s) in the rejected NSSAI list for which the NSACF has indicated that the maximum number of UEs per network slice has been reached and for each rejected S-NSSAI the AMF includes a reject cause set to ‘maximum number of UEs per network slice reached’, the dual steer indication, the access leg information associated with the rejection or acceptance e.g., the information of the first access leg (e.g., comprising the first access type and the first RAT type), information of the second access leg (e.g., comprising the first access type and the second RAT type) and a back-off timer.

In an example, the AMF may reject the UE request for registration. In an example, in the registration reject message, the AMF may include the rejected S-NSSAI(s) in the rejected NSSAI parameter and for each rejected S-NSSAI the AMF includes a reject cause to indicate that the maximum number of UEs per network slice has been reached and a back-off timer. In an example, the registration reject message may comprise a reject cause to indicate that the maximum number of UEs per network slice has been reached for dual steer connectivity. In an example, the registration reject message may comprise the dual steer indication, the access leg information associated with the rejection e.g., the information of the first access leg (e.g., comprising the first access type and the first RAT type), information of the second access leg (e.g., comprising the first access type and the second RAT type) the back-off timer, and/or the like.

In an example embodiment, the UE may attempt a registration with a third access (e.g., RAT 3) when receiving a rejection for registration via for one of the access legs.

In an example, upon successful registration for dual steer connection/functionality, the UE may proceed with establishment of MA-PDU session as described in example embodiments.

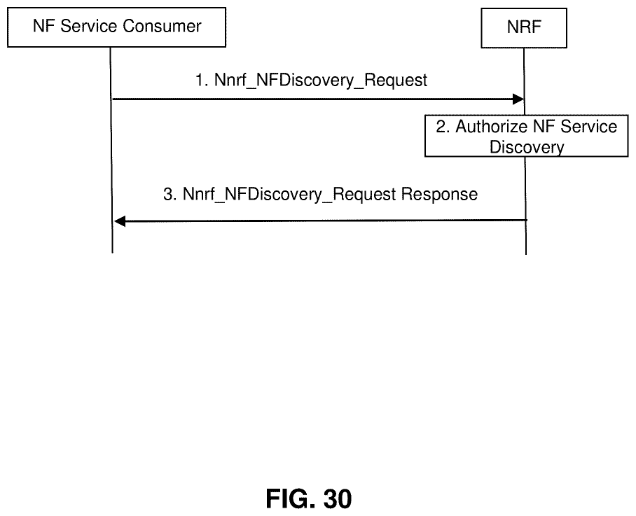

In an example embodiment as depicted in FIG. 30, NSACF discovery and selection may be performed. The NF consumers may utilize a NRF to discover NSACF instance(s), including the NSACF acting as Primary NSACF role, unless NSACF information is available by other means, e.g. locally configured in NF consumers. If the NSACF NF consumer is the AMF, the NSACF selection function in the AMF may select an NSACF instance based on the available NSACF instances, which are obtained from the NRF or locally configured in the AMF. In an example, the following factors may be considered by the NF consumer for NSACF selection:
dual steer (dualsteer) capability support indication.
MA-PDU capability support indication.
S-NSSAI(s).
NSACF Service Area information, or “Entire PLMN” for discovering the NSACF acting as Primary NSACF or central NSACF role. The NSACF service area is related to the location of the NF consumer.
NSACF service capabilities:
Support monitoring and controlling the number of registered UEs per network slice for the network slice that is subject to NSAC.
Support monitoring and controlling the number of established PDU Sessions per network slice for the network slice that is subject to NSAC.
PLMN ID information in the case of roaming to contact the HPLMN for inbound roamers.
an identifier of the underlay network when UE access an overlay network via the underlay network to contact the NSACF of the underlay network.
an identifier of the overlay network when UE access an underlay network to establish user plane connection for accessing the overlay network.

In an example, in the case of delegated discovery and selection in SCP, the NSACF NF consumer may send all available factors to the SCP.

In an example, the NF service consumer such as AMF, SMF, and/or the like may intend to discover services available in the network based on service name and target NF type. For example the NF may determine to discover or select a NSACF. The NF service consumer invokes Nnrf_NFDiscovery_Request (Expected NF service Name, NF Type of the expected NF instance, NF type of the NF consumer) from an appropriate configured NRF in the same PLMN. The parameter may comprise producer NF Set ID, NF Service Set ID, SUPI, Data Set Identifier(s), External Group ID (for UDM, UDR discovery), UE's Routing Indicator and Home Network Public Key identifier (for UDM and AUSF discovery), S-NSSAI, NSI ID if available and other service related parameters. In addition, for AMF discovery, the parameters may include AMF Region ID, AMF Set ID, TAI. In an example, the Nnrf_NFDiscovery_Request message may comprise a request for selection of the NSACF, dual steer (dualsteer) capability support indication, MA-PDU capability support indication, the extended access type via underlay indication, the indication of access to a network for establishing a user plane connection for overlay access, the underlay network ID, the overlay network ID, and/or the like.

In an example, the NRF authorizes the Nnrf_NFDiscovery_Request. Based on the profile of the expected NF/NF service and the type of the NF service consumer, the NRF determines whether the NF service consumer is allowed to discover the expected NF instance(s). If the expected NF instance(s) or NF service instance(s) are deployed in a certain network slice, NRF authorizes the discovery request according to the discovery configuration of the Network Slice, e.g. the expected NF instance(s) are only discoverable by the NF in the same network slice.

In an example, if allowed, the NRF may determine a set of NF instance(s) matching the Nnrf_NFDiscovery_Request and internal policies of the NRF and sends the NF profile(s) of the determined NF instances for the NSACF. Each NF profile containing at least the output required parameters to the NF service consumer via Nnrf_NFDiscovery_Request Response message. The response message may comprise information of the NSACF, NSACF ID, NSACF FQDN, dual steer (dualsteer) capability support indication, MA-PDU capability support indication, underlay network ID, overlay network ID, and/or the like.

In an example embodiment, AMF discovery and selection may be performed when the RAN node receives a message from the UE that comprises a dualsteer capability indication. In an example, the message may be an RRC message, registration request message, NAS message, and/or the like. In an example, the AMF discovery and selection functionality may be applicable to both 3GPP access and non-3GPP access. The AMF selection functionality may be supported by the 5G-AN (e.g. RAN, N31WF) and is used to select an AMF instance for a given UE. An AMF may support the AMF selection functionality to select an AMF for relocation or because the initially selected AMF was not an appropriate AMF to serve the UE (e.g. due to change of Allowed NSSAI). Other CP NF(s), e.g. SMF, supports the AMF selection functionality to select an AMF from the AMF set when the original AMF serving a UE is unavailable.

In an example, the 5G-AN may select an AMF Set and an AMF from the AMF Set under the following circumstances:
1) When the UE provides no 5G-S-TMSI nor the GUAMI to the 5G-AN.
2) When the UE provides 5G-S-TMSI or GUAMI but the routing information (i.e. AMF identified based on AMF Set ID, AMF pointer) present in the 5G-S-TMSI or GUAMI is not sufficient and/or not usable (e.g. UE provides GUAMI with an AMF region ID from a different region).
3) AMF has instructed AN that the AMF (identified by GUAMI(s)) is unavailable and no target AMF is identified and/or AN has detected that the AMF has failed.
4) When the UE attempts to establish a signalling connection, and the following conditions are met:
   the 5G-AN knows in what country the UE is located; and
   the 5G-AN is connected to AMFs serving different PLMNs of different countries; and
   the UE provides a 5G-S-TMSI or GUAMI, which indicates an AMF serving a different country to where the UE is currently located; and
   the 5G-AN is configured to enforce selection of the AMF based on the country the UE is currently located.

Then the 5G-AN shall select an AMF serving a PLMN corresponding to the UE's current location. How 5G-AN selects the AMF in this case is defined in TS 38.410 [125].

In the case of NF Service Consumer based discovery and selection, the CP NF selects an AMF from the AMF Set under the following circumstances:
When the AMF has instructed CP NF that a certain AMF identified by GUAMI(s) is unavailable and the CP NF was not notified of target AMF; and/or
CP NF has detected that the AMF has failed; and/or
When the selected AMF does not support the UE's Preferred Network Behaviour; and/or
When the selected AMF does not support the High Latency communication for NR RedCap UE.

In the case of delegated discovery and associated selection, the SCP selects an AMF from the corresponding AMF Set under the following circumstances:
The SCP gets an indication “select new AMF within SET” from the CP NF; and/or
SCP has detected that the AMF has failed.

The AMF selection functionality in the 5G-AN may consider the following factors for selecting the AMF Set:
Dualsteer capability indication;
MA PDU session capability;
AMF Region ID and AMF Set ID derived from GUAMI;
Requested NSSAI;
Local operator policies;
5G CloT features indicated in RRC signalling by the UE;
IAB-indication;
NB-IoT RAT Type;
Category M Indication;
NR RedCap Indication;
SNPN Onboarding indication as indicated in RRC signalling by the UE.

AMF selection functionality in the 5G-AN or CP NFs or SCP considers the following factors for selecting an AMF from AMF Set:
Availability of candidate AMF(s).
Load balancing across candidate AMF(s) (e.g. considering weight factors of candidate AMFs in the AMF Set).
In 5G-AN, 5G CloT features indicated in RRC signalling by the UE.
In 5G-AN, SNPN Onboarding indication as indicated in RRC signalling by the UE.

In an example, the NF service consumer such as the RAN node, N3IWF, the AMF, and/or the like may intend to discover services available in the network based on service name and target NF type. For example the NF may determine to discover or select an AMF. The NF service consumer invokes Nnrf_NFDiscovery_Request (Expected NF service Name, NF Type of the expected NF instance, NF type of the NF consumer) from an appropriate configured NRF in the same PLMN. The parameter may comprise producer NF Set ID, NF Service Set ID, SUPI, Data Set Identifier(s), External Group ID (for UDM, UDR discovery), UE's Routing Indicator and Home Network Public Key identifier (for UDM and AUSF discovery), S-NSSAI, NSI ID if available and other service related parameters. In addition, for AMF discovery, the parameters may include AMF Region ID, AMF Set ID, TAI. In an example, the Nnrf_NFDiscovery_Request message may comprise a request for selection of the AMF, dual steer (dualsteer) capability support indication, MA-PDU capability support indication, the extended access type via underlay indication, the indication of access to a network for establishing a user plane connection for overlay access, the underlay network ID, the overlay network ID, and/or the like.

In an example, the NRF authorizes the Nnrf_NFDiscovery_Request. Based on the profile of the expected NF/NF service and the type of the NF service consumer, the NRF determines whether the NF service consumer is allowed to discover the expected NF instance(s). If the expected NF instance(s) or NF service instance(s) are deployed in a certain network slice, NRF authorizes the discovery request according to the discovery configuration of the Network Slice, e.g. the expected NF instance(s) are only discoverable by the NF in the same network slice.

In an example, if allowed, the NRF may determine a set of NF instance(s) matching the Nnrf_NFDiscovery_Request and internal policies of the NRF and sends the NF profile(s) of the determined NF instances for the AMF. Each NF profile containing at least the output required parameters to the NF service consumer via Nnrf_NFDiscovery_Request Response message. The response message may comprise information of the AMF, AMF ID, AMF FQDN, dual steer (dualsteer) capability support indication, MA-PDU capability support indication, underlay network ID, overlay network ID, and/or the like.

In an example embodiment, SMF discovery and selection may be performed when the AMF node receives a message from the UE that comprises the dual steer capability indication. In an example, the message may be an N2 message, registration request message, NAS message, and/or the like. In an example, the SMF discovery and selection functionality may be applicable to both 3GPP access and non-3GPP access. The SMF selection functionality in the network or AMF may consider the following factors for selecting the SMF:
Dualsteer capability indication;
MA PDU session capability;
S-NSSAI;
Requested NSSAI;
5G CloT capability;

In an example, the NF service consumer such as the AMF, and/or the like may intend to discover services available in the network based on service name and target NF type. For example the NF may determine to discover or select an SMF. The NF service consumer invokes Nnrf_NFDiscovery_Request (Expected NF service Name, NF Type of the expected NF instance, NF type of the NF consumer) from an appropriate configured NRF in the same PLMN. The parameter may comprise producer NF Set ID, NF Service Set ID, SUPI, Data Set Identifier(s), External Group ID (for UDM, UDR discovery), UE's Routing Indicator and Home Network Public Key identifier (for UDM and AUSF discovery), S-NSSAI, NSI ID if available and other service related parameters. In addition, for SMF discovery, the parameters may include SMF Region ID. In an example, the Nnrf_NFDiscovery_Request message may comprise a request for selection of a SMF, dual steer (dualsteer) capability support indication, MA-PDU capability support indication, the extended access type via underlay indication, the indication of access to a network for establishing a user plane connection for overlay access, the underlay network ID, the overlay network ID, and/or the like.

In an example, if allowed, the NRF may determine a set of NF instance(s) matching the Nnrf_NFDiscovery_Request and internal policies of the NRF and sends the NF profile(s) of the determined NF instances for the SMF. Each NF profile containing at least the output required parameters to the NF service consumer via Nnrf_NFDiscovery_Request Response message. The response message may comprise information of the SMF, SMF ID, SMF FQDN, dual steer (dualsteer) capability support indication, MA-PDU capability support indication, underlay network ID, overlay network ID, and/or the like.

In an example embodiment, a session management function (SMF) may send to a network slice admission control function (NSACF), a message indicating that a number of PDU sessions for a multi-access protocol data unit (MA-PDU) session established on a network slice is to be increased. In an example, the message may comprise a first radio access technology (RAT) type of a first access type over which the MA-PDU session is to be established, a second RAT type of the first access type. In an example, the SMF may receive from the NSACF, a response message indicating whether a first maximum number of PDU sessions established on the network slice has been reached for the first RAT type and a second maximum number of PDU sessions established on the network slice has been reached for the second RAT type.

In an example embodiment, a session management function (SMF) may receive from a wireless device, a request to establish a multi-access protocol data unit (MA-PDU) session using a first RAT type of a first access type and a second RAT type of the first access type. In an example, the request may comprise an identifier of a network slice. In an example, the SMF may send to a network slice admission control function (NSACF), a message indicating that a number of PDU sessions for the MA-PDU session established on the network slice is to be increased. In an example, the message may comprise the first radio access technology (RAT) type of the first access type, and the second RAT type of the first access type. In an example, the SMF may receive from the NSACF, a response message indicating whether a first maximum number of PDU sessions established on the network slice has been reached for the first RAT type; and a second maximum number of PDU sessions established on the network slice has been reached for the second RAT type.

In an example, the message (sent from the SMF to the NSACF) may comprise an identifier of a first radio access network (RAN) associated with a first access leg of the MA-PDU session and an identifier of a second radio access network (RAN) associated with a second access leg of the MA-PDU session. In an example, the message (sent from the SMF to the NSACF) may comprise: an identifier of a first access leg of the MA-PDU session; and an identifier of a second access leg of the MA-PDU session. In an example, the SMF may send to the wireless device a NSA message indicating a result of the request (for PDU session). In an example, the NAS message may comprise the RAT type, and a back-off timer. In an example, the NAS message may indicate whether: the first maximum number of PDU sessions established on the network slice has been reached for the first RAT type and the second maximum number of PDU sessions established on the network slice has been reached for the second RAT type. In an example, the message may comprises a request type indicating an MA-PDU session, a dual steer indication, and/or the like. In an example, the message may comprise an identifier of the access leg of the MA-PDU session. In an example, the SMF may receive from the NSACF, a response message indicating that the maximum number of PDU sessions established on the network slice has been reached for the RAT type (e.g., the first RAT type and/or the second RAT type). In an example, the SMF may receive and upon expiry of the back-off timer, from the wireless device, a second request to establish the MA-PDU session. In an example, the SMF may receive from the wireless device a second request to establish the MA-PDU session via a third RAT type. In an example, the back-off timer may be associated with access of the wireless device via the RAT type (e.g., the first RAT type and/or the second RAT type) e.g., a first back-off timer associated with ethe first RAT type and a second back-off timer associated with the second RAT type. In an example, the response message may indicate the maximum number of PDU sessions established on the network slice has been reached for access of the wireless device via the RAT type. In an example, the response message may comprise the back-off timer. In an example, the SMF may receive from the wireless device, a PDU session modification request message (e.g., for an access leg of the MA-PDU session, or a PDU session) comprising an identifier of a second network slice. In an example, the SMF may send to the NSACF an update flag indicating update of network slice information associated with the access type and the RAT type. In an example, the message may comprise an update flag indicating increase which indicates that the number of PDUs established on the network slice is to be increased when the procedure is triggered at the beginning of PDU Session Establishment procedure or when a new user plane leg is to be established for an MA PDU Session. In an example, the SMF may (determine to) release an access leg of the MA-PDU session. In an example, the access leg may be associated with at least one of the first radio access technology (RAT) type of the first access type, and the second RAT type of the first access type. In an example, the release may comprise a deactivation of the access leg. In an example, the deactivation or release may be determined or performed based on receiving a notification of inactivity for the access leg of the MA-PDU session for a duration of time being equal to an inactivity timer. In an example, the notification may be received from a UPF. In an example, the message may comprises an update flag indicating decrease which indicates that the number of PDU Sessions on the network slice is to be decreased when the procedure is triggered at the end of PDU sessions release or deactivation procedure or when an existing user plane leg is to be released or deactivated for an MA PDU Session. In an example, the message may further comprise an update flag indicating update which indicates that for existing PDU session the access type and RAT type is to be replaced with a new access type and RAT type during inter access mobility. OR the PDU session (or MA-PDU session) associated with the access type and RAT type, change the S-NSSAI (e.g., PDU session modification with S-NSSAI change). In an example, the SMF may select and based on a dual steer indication, an ATSSS capability indication (or dual steer MA-PDU capability), the NSACF. In an example, the SMF may send to a network repository function (NRF) a discovery request message indicating a request to select a NSCAF, the discovery request message comprising at least one of: one or more network slice identifiers associated with one or more accesses of the MA-PDU session, an MA-PDU session capability indication, an ATSSS capability indication, a dual steer (capability) indication, a dual steer MA-PDU capability, and/or the like. In an example, the SMF may receive from the NRF, an identifier of the NSACF that supports admission control for MA-PDU session, dual steer MA-PDU session, dual steer functionality.

In an example embodiment, a wireless device may send to a session management function (SMF), a request to establish a multi-access protocol data unit (MA-PDU) session. In an example, the request may comprise an identifier of a network slice. In an example, the wireless device may receive from the SMF, a non-access stratum (NAS) message indicating whether: a first maximum number of PDU sessions established on the network slice has been reached for a first RAT type, and a second maximum number of PDU sessions established on the network slice has been reached for a second RAT type.

In an example, a first access leg of the MA-PDU session may be associated with a first access type and a first RAT type; and a second access leg may be associated with the first access type and a second RAT type. In an example, the NAS message may comprises a back-off timer. In an example, the NAS message may comprises a first back-off timer associated with the first RAT type and a second back-off timer associated with the second RAT type.

In an example embodiment, a wireless device may send to a session management function (SMF), a request to establish a multi-access protocol data unit (MA-PDU) session, the request comprising an identifier of a network slice. In an example, the wireless device may receive from the SMF, a non-access stratum (NAS) message indicating the maximum number of PDU Sessions established on the S-NSSAI has been reached, the NAS message comprising a radio access technology (RAT) type associated with an access leg of the MA-PDU session. In an example, the NAS message may comprise a back-off timer associated with the RAT type.

In an example embodiment, a session management function (SMF) may receive from a wireless device, a request to establish a multi-access protocol data unit (MA-PDU) session using a first RAT type of a first access type and a second RAT type of the first access type, the request comprising an identifier of a network slice. In an example, the SMF may send (based on the request) to a network slice admission control function (NSACF), a message indicating that a number of PDU sessions established on the network slice is to be increased, the message comprising: the first radio access technology (RAT) type of the first access type over which the MA-PDU session is to be established; and the second RAT type of the first access type. In an example, the SMF may receive from the NSACF, a response message indicating that the maximum number of PDU sessions established on the network slice has been reached for at least one of the first RAT type, the second RAT type. In an example, the SMF may send to the wireless device, a non-access stratum (NAS) message indicating that the maximum number of PDU Sessions established on the network slice has been reached.

In an example embodiment, a session management function (SMF) may send to a network slice admission control function (NSACF), a message indicating that a number of PDU sessions for a multi-access protocol data unit (MA-PDU) session established on a network slice is to be increased, the message comprising: a first radio access technology (RAT) type of a first access type over which the MA-PDU session is to be established, and a second RAT type of the first access type. In an example, the SMF may receive from the NSACF, a response message indicating whether a maximum number of PDU sessions established on the network slice has been reached for each of: the first RAT type, the second RAT type.

In an example embodiment, an access and mobility management function (AMF) may receive from a wireless device, a request to register (e.g., NAs message, MM-NAS message, registration request message, and/or the like) for dual steer connection. In an example, the request to register may employ at least one of a first RAT type of a first access type and a second RAT type of the first access type. In an example, the request may comprise an identifier of a network slice. In an example, the AMF may send to a network slice admission control function (NSACF), a message indicating that a number of wireless devices for the dual steer connection on the network slice is to be increased, the message comprising: the first radio access technology (RAT) type of the first access type, the second RAT type of the first access type. In an example, the AMF may receive from the NSACF, a response message indicating whether: a first maximum number of wireless devices on the network slice has been reached for the first RAT type, and a second maximum number of wireless devices on the network slice has been reached for the second RAT type. In an example, the AMF may send to the wireless device, a NAS (DL NAS) message indicating whether: the first maximum number of wireless devices on the network slice has been reached for the first RAT type; and the second maximum number of wireless devices on the network slice has been reached for the second RAT type.

In an example, the NAS message (DL NAS) may comprise a back-off timer. In an example, the back-off timer may be associated with a RAT type. In an example, the NAS message may comprise a first back-off timer associated with the first access leg and a second back-off timer associated with the second access leg.

What is claimed is:

1. A method comprising:
receiving, by a first network node from a second network node, a message indicating whether:
a first maximum number of protocol data unit (PDU) sessions, of a multi-access protocol data unit (MA-PDU) session established for a wireless device on a network slice, has been reached for a first radio access technology (RAT) type; or
a second maximum number of PDU sessions established on the network slice has been reached for a second RAT type.

2. The method of claim 1, wherein the first network node comprises the wireless device.

3. The method of claim 2, wherein the second network node comprises one of a session management function (SMF) or an access and mobility management function (AMF).

4. The method of claim 2, wherein:
the second network node comprises a session management function (SMF); and
the wireless device sends, to the SMF, a request to establish the MA-PDU session, the request comprising an identifier of the network slice.

5. The method of claim 2, wherein the message comprises a network access stratum (NAS) message, wherein the NAS message comprises one or more back-off timers.

6. The method of claim 5, wherein the one or more back-off timers comprise a first back-off timer associated with the first RAT type and a second back-off timer associated with the second RAT type.

7. The method of claim 2, wherein:
the second network node comprises an access and mobility management function (AMF); and
the wireless device sends, to the AMF, a request to register the MA-PDU session using the first RAT type and the second RAT type, the request comprising an identifier of the network slice.

8. A first network node comprising one or more processors and memory storing instructions that, when executed by the one or more processors, cause the first network node to:
receive, from a second network node, a message indicating whether:
a first maximum number of protocol data unit (PDU) sessions, of a multi-access protocol data unit (MA-PDU) session established for a wireless device on a network slice, has been reached for a first radio access technology (RAT) type; or
a second maximum number of PDU sessions established on the network slice has been reached for a second RAT type.

9. The first network node of claim 8, wherein the first network node comprises the wireless device.

10. The first network node of claim 9, wherein the second network node comprises one of a session management function (SMF) or an access and mobility management function (AMF).

11. The first network node of claim 9, wherein:
the second network node comprises a session management function (SMF); and
the wireless device sends, to the SMF, a request to establish the MA-PDU session, the request comprising an identifier of the network slice.

12. The first network node of claim 9, wherein the message comprises a network access stratum (NAS) message, wherein the NAS message comprises one or more back-off timers.

13. The first network node of claim 12, wherein the one or more back-off timers comprise a first back-off timer associated with the first RAT type and a second back-off timer associated with the second RAT type.

14. The first network node of claim 9, wherein:
the second network node comprises an access and mobility management function (AMF); and
the wireless device sends, to the AMF, a request to register the MA-PDU session using the first RAT type and the second RAT type, the request comprising an identifier of the network slice.

15. A non-transitory computer-readable medium comprising instructions that, when executed by one or more processors, cause a first network node to:
receive, from a second network node, a message indicating whether:
a first maximum number of protocol data unit (PDU) sessions, of a multi-access protocol data unit (MA-PDU) session established for a wireless device on a network slice, has been reached for a first radio access technology (RAT) type; or
a second maximum number of PDU sessions established on the network slice has been reached for a second RAT type.

16. The non-transitory computer-readable medium of claim 15, wherein the first network node comprises the wireless device.

17. The non-transitory computer-readable medium of claim 16, wherein the second network node comprises one of a session management function (SMF) or an access and mobility management function (AMF).

18. The non-transitory computer-readable medium of claim 16, wherein:
the second network node comprises a session management function (SMF); and
the wireless device sends, to the SMF, a request to establish the MA-PDU session, the request comprising an identifier of the network slice.

19. The non-transitory computer-readable medium of claim 16, wherein the message comprises a network access stratum (NAS) message, wherein the NAS message comprises one or more back-off timers.

20. The non-transitory computer-readable medium of claim 19, wherein the one or more back-off timers comprise a first back-off timer associated with the first RAT type and a second back-off timer associated with the second RAT type.
